(19) United States
(12) Patent Application Publication
(10) Pub. No.: US 2026/0065233 A1
(43) Pub. Date: Mar. 5, 2026

(54) TECHNOLOGIES FOR AUTOMATED SCHEDULING OF MEETINGS

(71) Applicant: BVS Holdings, LLC, Boston, MA (US)

(72) Inventors: Paul English, Boston, MA (US); Samuel Cohen, Aventura, FL (US); Rachel Cohen, Boston, MA (US); Swagata Chakrabarti, Boston, MA (US); Ahmed Faraz, Punjab (PK)

(21) Appl. No.: 19/007,087

(22) Filed: Dec. 31, 2024

Related U.S. Application Data
(63) Continuation-in-part of application No. 18/822,636, filed on Sep. 3, 2024.

(51) Int. Cl. G06Q 10/1093; G06Q 10/107

(52) U.S. Cl. CPC G06Q 10/1093; G06Q 10/107

(57) ABSTRACT

Technologies for automated scheduling of meetings includes receiving an email communication including an indication of a request to schedule the meeting. In response, each day within a range of days is allocated into time slots and each time slot is assigned an availability score based on an indicated availability of each participant of the requested meeting. Each time slot is assigned a time slot score based on the availability score, a time slot bonus based on the time of day of the corresponding time slot, and a day penalty based on a temporal distance to the day in which the corresponding time slot occurs. The time slot in which to schedule the meeting is selected based on the time slot score of each corresponding time slot. If a time slot within a reference day range cannot be identified, one or more conflicting meetings may be rescheduled to a new time slot based on various characteristics of the requested meeting, the conflicting meeting, and the new time slot.

### TECHNOLOGIES FOR AUTOMATED SCHEDULING OF MEETINGS

The present application is a continuation-in-part of U.S. patent application Ser. No. 18/822,636, entitled “TECHNOLOGIES FOR AUTOMATED SCHEDULING OF MEETINGS,” which was filed on Sep. 3, 2024, the entirety of which is incorporated herein by reference.

### FIELD OF THE DISCLOSURE

The present disclosure relates generally to technologies for scheduling a meeting and, more particularly, to technologies for automated scheduling of digital meetings based on electronic mail (“email”) communications.

### BACKGROUND

Due to the ever increasing mobility of individuals, the facilitation of remote work, increased travel, complex schedules, and other factors, the scheduling of meetings for both personal and business purposes has vastly increased in importance. For personal use, scheduled meetings provide a reminder of a commitment to connect, attend an event, or engage in other social activities. For business use, scheduled meetings provide a defined time for team members to discuss matters of business. In particular, the recent increased use of digital or virtual meetings allow participants who may be physically or geographically separated from each other to attend the meeting.

However, scheduling a meeting can be difficult for a variety of reasons. For example, as the number of participants of the meeting grows, the difficulty in identifying a common meeting day and time that is acceptable to all participants increases. Additionally, it can be difficult to determine who should be invited to a particular meeting. Furthermore, determining the acceptable length of the meeting can be challenging, especially when the meeting length causes scheduling conflicts between participants. Typically, the scheduling details of a proposed meeting are determined via multiple back-and-forth email correspondences, phone calls, and/or other forms of contact between the participants, which can be time intensive and ultimately delay the scheduling of the meeting. Furthermore, in situations in which rescheduling of a meeting is required, such rescheduling typically occurs ad hoc and can be an onerous, iterative task that adds additional time and complexity. While the scheduling and rescheduling of meetings is transactional in nature, those activities are often necessary prerequisites to the finalization of a meeting.

### SUMMARY

According to an aspect of the present disclosure, a method for automated scheduling of a meeting may include receiving, by a server computer, an email communication from a sender and determining, by the server computer, whether to schedule the meeting based on whether the email communication includes an indicator that indicates a desire by the sender to schedule the meeting. The method may also include analyzing, by the server computer and in response to a determination to schedule the meeting, the email communication to determine a set of participants for the meeting. The set of participants may include a host identified as the sender of the email communication and at least one invitee. The method may further include analyzing, by the server computer and in response to the determination to schedule the meeting, the email communication to determine a set of meeting parameters. The set of meeting parameters may define characteristics of the meeting. The method may also include analyzing, by the server computer, a digital calendar of each participant of the set of participants to identify a time slot that satisfies the set of meeting parameters and scheduling, by the server computer, the meeting on the digital calendar of each participant of the set of participants at the identified time slot.

In some embodiments, determining whether to schedule the meeting may include determining whether a reference email address is included in the email communication. Additionally, in some embodiments, analyzing the email communication to determine a set of participants for the meeting may include determining each recipient of the email communication. Additionally or alternatively, in some embodiments, analyzing the email communication to determine a set of participants for the meeting may include analyzing the email to determine a participant of the meeting that is (i) mentioned in the email communication and (ii) not a recipient of the email communication.

Additionally, in some embodiments, analyzing the email communication to determine the set of meeting parameters may include setting each meeting parameter of the set of meeting parameters to a default parameter. Additionally or alternatively, analyzing the email communication to determine the set of meeting parameters may include analyzing the email communication to determine a meeting subject, a meeting duration, a meeting date, or a meeting time for the meeting.

In some embodiments, analyzing the email communication to determine the set of meeting parameters may include determining at least one meeting parameter of the set of meeting parameters based on a user-defined preference of a participant of the set of participants of the meeting. Additionally or alternatively, analyzing the email communication to determine the set of meeting parameters may include determining at least one meeting parameter of the set of meeting parameters based on a user history of a participant of the set of participants of the meeting.

Additionally, in some embodiments, analyzing the digital calendar of each participant of the set of participants to identify the time slot that satisfies the set of meeting parameters include identifying, by the server computer, a conflicting meeting of at least one participant of the set of participants that conflicts with the identified time slot; determining, by the server computer, whether the conflicting meeting can be rescheduled; and adjusting, by the server computer, the conflicting meeting on the digital calendar of the at least one participant to a different time slot than the identified time slot. In such embodiments, determining whether the conflicting meeting can be rescheduled may include determining whether the conflicting meeting can be rescheduled based on a characteristic of the conflicting meeting. For example, the characteristic of the conflicting meeting may include at least one of a subject matter of the conflicting meeting, a number of participants of the conflicting meeting, and a location of the conflicting meeting. Additionally or alternatively, determining whether the conflicting meeting can be rescheduled may include determining whether the conflicting meeting can be rescheduled based on a characteristic of the least one participant of the set of participants. For example, the characteristic of the least one participant of the set of participants may include a user preference, a user history, or a user priority of the least one participant of the set of participants.

According to another aspect of the present disclosure, a server computer for automated scheduling of a meeting may include a processor and a memory having stored therein a plurality of instructions that, when executed by the processor, cause the server computer to determine whether to schedule the meeting based on whether an email communication received by the server computer and from a sender includes an indicator that indicates a desire by the sender to schedule the meeting. The plurality of instructions may further cause the server computer to analyze, in response to a determination to schedule the meeting, the email communication to determine a set of participants for the meeting. The set of participants may include a host identified as the sender of the email communication and at least one invitee. The plurality of instructions may also cause the server computer to analyze, in response to the determination to schedule the meeting, the email communication to determine a set of meeting parameters. The set of meeting parameters may define characteristics of the meeting. Additionally, the plurality of instructions may cause the server computer to analyze a digital calendar of each participant of the set of participants to identify a time slot that satisfies the set of meeting parameters and schedule the meeting on the digital calendar of each participant of the set of participants at the identified time slot.

In some embodiments, to analyze the digital calendar of each participant of the set of participants to identify the time slot that satisfies the set of meeting parameters comprises to identify a conflicting meeting of at least one participant of the set of participants that conflicts with the identified time slot, determine whether the conflicting meeting can be rescheduled, and adjust the conflicting meeting on the digital calendar of the at least one participant to a different time slot than the identified time slot. For example, to determine whether the conflicting meeting can be rescheduled may include to determine whether the conflicting meeting can be rescheduled based on a characteristic of the conflicting meeting or on a characteristic of the least one participant of the set of participants.

According to yet a further aspect of the present disclosure, one or more non-transitory, computer-readable storage media comprising a plurality of instructions that, in response to execution, cause a server computer to determine whether to schedule the meeting based on whether an email communication received by the server computer and from a sender includes an indicator that indicates a desire by the sender to schedule the meeting. The plurality of instructions may further cause the server computer to analyze, in response to a determination to schedule the meeting, the email communication to determine a set of participants for the meeting. The set of participants may include a host identified as the sender of the email communication and at least one invitee. The plurality of instructions may also cause the server computer to analyze, in response to the determination to schedule the meeting, the email communication to determine a set of meeting parameters. The set of meeting parameters may define characteristics of the meeting. Additionally, the plurality of instructions may cause the server computer to analyze a digital calendar of each participant of the set of participants to identify a time slot that satisfies the set of meeting parameters and schedule the meeting on the digital calendar of each participant of the set of participants at the identified time slot.

In some embodiments, to analyze the digital calendar of each participant of the set of participants to identify the time slot that satisfies the set of meeting parameters comprises to identify a conflicting meeting of at least one participant of the set of participants that conflicts with the identified time slot, determine whether the conflicting meeting can be rescheduled, and adjust the conflicting meeting on the digital calendar of the at least one participant to a different time slot than the identified time slot. For example, to determine whether the conflicting meeting can be rescheduled may include to determine whether the conflicting meeting can be rescheduled based on a characteristic of the conflicting meeting or on a characteristic of the least one participant of the set of participants.

According to another aspect of the present disclosure, a method for automated scheduling of a meeting may include receiving, by a server computer, an email communication from a sender, the email including an indicator that indicates a request by the sender to schedule the meeting and determining, by the server computer, a set of participants for the requested meeting based on the email. The method may also include allocating, by the server computer, each day within a range of days into time slots having predefined temporal lengths to define a plurality of time slots and assigning, by the server computer, an availability score for each time slot of the plurality of time slots based on an indicated availability of each participant of the set of participants for the corresponding time slot. The method may additionally include determining, by the server computer, a time slot bonus for each time slot of the plurality of time slots based on the time of day associated with the corresponding time slot, determining, by the server computer, a day penalty for each time slot of the plurality of time slots based on a temporal distance from a present day to the day in which the corresponding time slot occurs, and determining, by the server computer, a time slot score for each time slot of the plurality of time slots based on the availability score, the time slot bonus, and the day penalty associated with each corresponding time slot. Furthermore, the method may include selecting, by the server computer, a time slot from the plurality of time slots based on the time slot score of each corresponding time slot and scheduling, by the server computer, the requested meeting for the selected time slot on a digital calendar of each participant of the set of participants.

In some embodiments, allocating each day into time slots may include allocating each day into 30 minute time slots. Additionally, in some embodiments, assigning the availability score may include assigning, by the server computer, a higher availability score to a time slot of the plurality of time slots in response to a determination that a participant associated with the time slot is available and a lower availability score if the participant associated with the time slot is not available. Additionally or alternatively, assigning the availability score may include classifying each participants availability within each time slot into one of three classifications including an available category, a not-available category, and an available-if-required category. In some embodiments, the time slot bonus may be greater for those time slots corresponding to an hour between 9:00 AM and 5:00 PM relative to those time slots occur at another time on the same day.

Additionally, in some embodiments, determining a day penalty for each time slot of the plurality of time slots may include assigning, by the server computer, a first day penalty to a first time slot of the plurality of time slots and a second day penalty to a second time slot of the plurality of time slots. In such embodiments, the first day penalty is greater than the second day penalty and the first time slot occurs on a day that is subsequent to a day on which the second time slot occurs.

In some embodiments, wherein determining the time slot score for each time slot of the plurality of time slots may include determining a base time slot score for each time slot of the plurality of time slots as a sum of the (i) number of participants available for the corresponding time slot weighted by a first weighting factor and (ii) the number of participants available-if-required for the corresponding time slot weighted by a second weighting factor different from the first weighting factor. In such embodiments, determining the time slot score for each time slot of the plurality of time slots may include determining, by the server computer, the total time slot score by adding the time slot bonus for each respective time slot to the base time slot score determined for that respective time slot and subtracting the day penalty determined for that respective time slot.

Additionally, in some embodiments, determining the time slot score for each time slot of the plurality of time slots may include determining, by the server computer, the time slot score for each respective time slot according to the following equation: TSₜ=ASₜ+TBₜ-DPₜ, wherein TSₜ is the time slot score for time slot “t”, ASₜ is the availability score for time slot “t”, and DPₜ is the day penalty slot score for time slot “t”.

In some embodiments, the method may further include identifying, by the server computer, a conflicting meeting of at least one participant of the set of participants that conflicts with the selected time slot; determining, by the server computer, whether the conflicting meeting can be rescheduled; and adjusting, by the server computer, the conflicting meeting on the digital calendar of the at least one participant to a different time slot than the selected time slot. In such embodiments, determining whether the conflicting meeting can be rescheduled may include determining, by the server computer, a participant priority score (PPS) for each participant of the set of participants; determining, by the server computer, a meeting reschedule score (MRS) for each of the requested meeting and the conflicting meeting; determining, by the server computer, a time sensitivity score (TSS) for each of the requested meeting and the conflicting meeting; and determining, by the server computer, a meeting priority score (MPS) for each of the requested meeting and the conflicting meeting as a function of the participant priority score, the meeting schedule score, and the time sensitivity score for each respective meeting. The method may further include determining, by the server computer, whether the conflicting meeting can be rescheduled based on the meeting priority score of the requested meeting and the meeting priority score of the conflicting meeting. The participant priority score may be indicative of an importance of each participant relative to the other participants of the set of participants. The meeting reschedule score may be indicative of a difficulty of rescheduling the corresponding meeting. Additionally, the time sensitivity score may be indicative of an urgency of the corresponding meeting, and the meeting priority score may be indicative of a relative priority of the corresponding meeting.

In some embodiments, determining the participant priority may include determining, by the server computer and for each participant of the set of participants, a calendar score based on an amount of availability of the corresponding participant over a defined time period; determining, by the server computer and for each participant of the set of participants, a hierarchy score indicative of a seniority of the corresponding participant relative to other participants of the set of participants; and determining, by the server computer, the participant priority score (PPS) for each participant of the set of participants based on the calendar score and the hierarchy score determined for each corresponding participant. Additionally or alternatively, determining the meeting reschedule score for each of the requested meeting and the conflicting meeting may include determining, by the server computer, a base meeting reschedule score for each of the requested meeting and the conflicting meeting as a function of a company affiliation and a registration status of each participant; adjusting, by the server computer, the base meeting reschedule score in response to determination of whether the conflicting meeting has previously been rescheduled; and adjusting, by the server computer, the base meeting reschedule score in response to a determination of a level of importance of the corresponding conflicting meeting and requested meeting. The company affiliation may be indicative of whether the corresponding participant is an employee of the same company as the sender. Additionally, the registration status may be indicative of whether the corresponding participant utilizes a digital calendar maintained by the server computer.

Additionally, in some embodiments, determining the time sensitivity score may include determining, by the server computer, a context of each of the requested meeting and the conflicting meeting and determining, by the server computer, a time sensitivity score (TSS) for each of the requested meeting and the conflicting meeting based on the determined context of the corresponding requested meeting and conflicting meeting.

In some embodiments, determining the meeting priority score for each of the requested meeting and the conflicting meeting may include determining, by the server computer, an average participant priority score (APPS) as a function of the participant priority score (PPS) for each participant of each corresponding requested meeting and conflicting meeting and a total number of participants for each corresponding requested meeting and conflicting meeting. Additionally, determining the meeting priority score for each of the requested meeting and the conflicting meeting may include normalizing, by the server computer, each meeting reschedule score (MRS), each average participant priority score (APPS), and each time sensitivity score (TTS) to a score in the range of 0 to 1.0 and determining, by the server computer, the meeting priority score for each of the requested meeting and the conflicting meeting as a sum of the corresponding normalized MRS weighted by a first weighting factor, the corresponding normalized APPS weighted by a second weighting factor, and the normalized TTS weighted by a third weighting factor. In such embodiments, for example, determining the meeting priority score for each of the requested meeting and the conflicting meeting may include determining the meeting priority score according to the following equation: MPSm=(nMRSₘ×WF1)+ (nAPPSₘ× WF2)+ (nTSSₘ×WF3), wherein MPSₘ is the meeting priority score for meeting “m”, nMRSₘ is the normalized meeting reschedule score for meeting “m”, WF1 is the first weighting factor, nAPPSₘ is the normalized average participant priority score for meeting “m”, WF2 is the second weighting factor, nTSSₘ is the normalized time sensitivity score for meeting “m”, and WF3 is the third weighting factor.

Additionally, in some embodiments, the method may further include identifying, by the server computer, a set of identified time slots within the range of days from the conflicting meeting to which the conflicting meeting may be moved; and determining, by the server computer, a participant preference score difference (PSD) for each identified time slot. The participant preference score may define a preference of a corresponding participant for the conflicting meeting relative to the corresponding identified time slot. The method may also include determining, by the server computer, a time delay cost (TDC) for each identified time slot. The time delay cost may be indicative of a reduction of an urgency of the conflicting meeting as a function of temporal distance between the conflicting meeting and the corresponding time slot. Furthermore, the method may include determining, by the server computer, a rescheduling cost (RC) for each conflicting meeting as a function of the meeting priority score (MPS) of the conflicting meeting, the participant preference score difference (PSD) for each participant of the conflicting meeting, and the time delay cost (TDC) of the corresponding identified time slot. The method may also include selecting a time slot associated with one or more conflicting meetings based on the rescheduling cost (RC) of each identified time slot.

In such embodiments, determining the rescheduling cost (RC) for each identified slot may include determining the rescheduling cost according to the following equation: RCₛ=(MPS_{c}×WF1)+ (PSD_{c}×WF2)+ (TDCₛ×WF3), wherein RCₛ is the rescheduling cost for the identified time slot “s,” MPS_{c} is the meeting priority score for conflicting meeting “c”, WF1 is a first weighting factor, PSD_{c} is the participant preference score difference for each participant of the conflicting meeting “c”, WF2 is a second weighting factor, TDCₛ is the time delay cost for the identified time slot “s”, and WF3 is a third weighting factor. Additionally, in such embodiments, selecting the time slot associated with one or more conflicting meetings may include selecting the time slot having the lowest rescheduling cost (RC). Furthermore, in such embodiments, determining whether it can be moved may include the rescheduling cost of the conflicting meeting to a rescheduling cost of another conflicting meeting occurring in a different time slot.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for automated scheduling of meetings;

FIG. 2 is a simplified block diagram of an environment that may be established by a calendar scheduling server of the system of FIG. 1;

FIG. 3 is a simplified block diagram of an environment that may be established by a user computer device of the system of FIG. 1;

FIGS. 4A and 4B are a simplified flow diagram of at least one embodiment of a method for automated scheduling of a meeting that may be executed by the calendar scheduling server of FIGS. 1 and 2;

FIG. 5 is a simplified flow diagram of at least one embodiment of a method for determining meeting participants that may be executed by the calendar scheduling server of FIGS. 1 and 2 as a portion of the method of FIG. 4;

FIG. 6 is a simplified flow diagram of at least one embodiment of a method for determining meeting parameters that may be executed by the calendar scheduling server of FIGS. 1 and 2 as a portion of the method of FIG. 4;

FIGS. 7A-7C are a simplified flow diagram of at least one embodiment of a method for determining an available meeting time slot for each meeting participant that satisfies the meeting parameters, which may be executed by the calendar scheduling server of FIGS. 1 and 2 as a portion of the method of FIG. 4;

FIG. 8 is a simplified flow diagram of at least one embodiment of a process flow of a transmission of an email communication from a user computer device of the system of FIG. 1 to the calendar scheduling server of the system of FIG. 1 through several intervening servers of the network of the system of FIG. 1;

FIG. 9 is an illustrative table of estimated best and worst times for completion of processes of the process flow of FIG. 8;

FIG. 10 is a simplified flow diagram of at least one embodiment of a process flow of a transmission of an email communication from a user computer device of the system of FIG. 1 to the calendar scheduling server of the system of FIG. 1 in an embodiment in which the calendar scheduling server is embodied as a dedicated server;

FIG. 11 is a simplified flow diagram of at least one embodiment of a process flow of a transmission of an email communication from a user computer device of the system of FIG. 1 to the calendar scheduling server of the system of FIG. 1 in an embodiment in which the calendar scheduling server is embodied as a server dedicated to a single enterprise;

FIG. 12 is an illustration of a user interface that may be displayed on a user computer device of the system of FIG. 1 during the execution of the method of FIG. 4 by the calendar scheduling server of FIGS. 1 and 2;

FIG. 13 is an illustration of another user interface that may be displayed on a user computer device of the system of FIG. 1 during the execution of the method of FIG. 4 by the calendar scheduling server of FIGS. 1 and 2;

FIG. 14 is an illustration of another user interface that may be displayed on a user computer device of the system of FIG. 1 during the execution of the method of FIG. 4 by the calendar scheduling server of FIGS. 1 and 2;

FIG. 15 is an illustration of another user interface that may be displayed on a user computer device of the system of FIG. 1 during the execution of the method of FIG. 4 by the calendar scheduling server of FIGS. 1 and 2;

FIGS. 16A and 16B are a simplified flow diagram of another embodiment of a method for automated scheduling of a meeting that may be executed by the calendar scheduling server of FIGS. 1 and 2;

FIG. 17 is a simplified flow diagram of an embodiment of a method for selecting a time slot for a meeting on a digital calendar of a set of meeting participants, which may be executed by the calendar scheduling server of FIGS. 1 and 2 as a portion of the method of FIGS. 16A and 16B;

FIG. 18 is a simplified digital calendar allocated into time slots that provides an indication of a participant's availability for each time slot, which the calendar scheduling server of FIGS. 1 and 2 may analyze as a portion of the method of FIG. 17;

FIG. 19 is a simplified embodiment of a time chart indicating a time slot bonus for each time slot of a given day, which the calendar scheduling server of FIGS. 1 and 2 may use during execution of the method of FIG. 17;

FIGS. 20A-20C are a simplified flow diagram of an embodiment of a method for automated rescheduling of conflicting meetings of participants, which may be executed by the calendar scheduling server of FIGS. 1 and 2 as a portion of the method of FIGS. 16A and 16B;

FIGS. 21A and 21B are a simplified flow diagram of an embodiment of a method for adjusting the meeting time of one or more conflicting meetings; and

FIG. 22 is a simplified flow diagram of an embodiment of a method for identifying available time slots for unregistered users.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

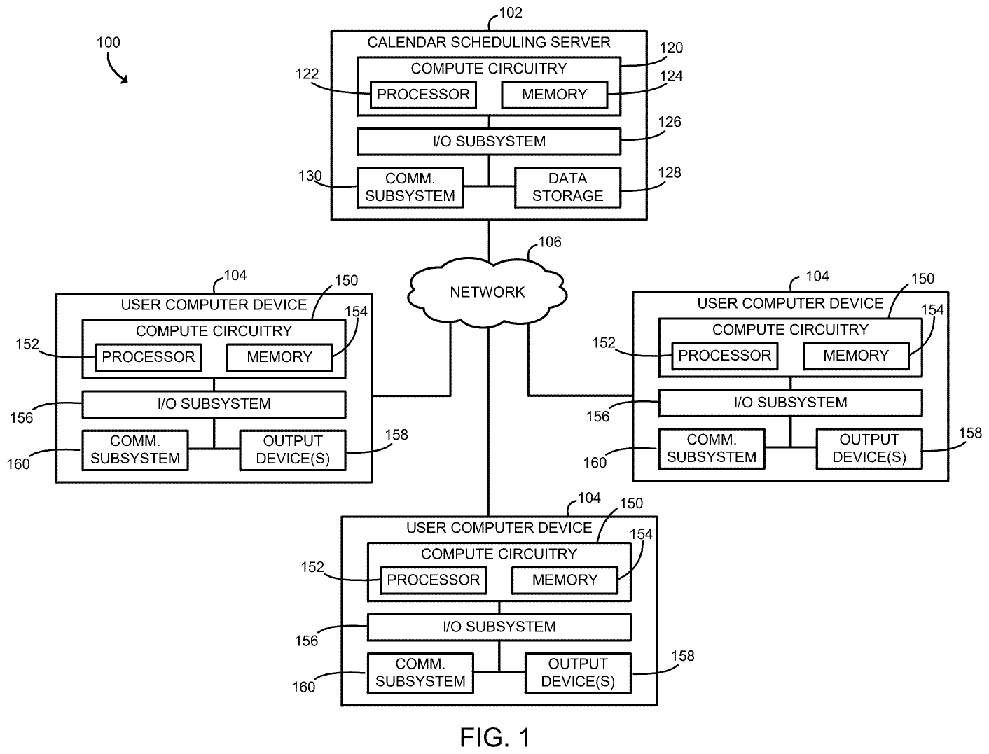

Referring now to FIG. 1, an illustrative system 100 for automated scheduling of meetings includes a calendar scheduling server 102 and a set of user computer devices 104, which are configured to communicate with the calendar scheduling server 102 over a network 106. In use, as discussed in more detail below, a user of one of the user computer devices 104 (i.e., the “host”) may request the automated scheduling of a meeting with the users of other user computer devices 104 (i.e., the “invitees”) by including an email address managed by the calendar scheduling server 102, or other indicator, on an email communication to those other users. In response to receiving the email communication, the calendar scheduling server 102 is configured to schedule a meeting between each user of the user computer devices 104, including the sender of the email communication, in an automated fashion.

To do so, the calendar scheduling server 102 analyzes the email communication to determine the set of participants that should be included in the meeting, which includes the original sender of the email communication as the host and the other users of the user computer devices 104 as the invitees of the to-be-scheduled meeting. As discussed in more detail below, the calendar scheduling server 102 may determine the set of participants by analyzing the sender and other recipients of the email communication, by identifying participants referenced in the body of the email commutation (e.g., throughout the email communication), and/or by inferring participants of the meeting based on the content of the email communication, user preferences, user history, and/or other considerations.

The calendar scheduling server 102 is also configured to analyze the email communication to determine a set of meeting parameters that the to-be-scheduled meeting should satisfy (e.g., meeting duration, meeting day, meeting time, etc.). The calendar scheduling server 102 may determine the meeting parameters based on any suitable data or analysis techniques such a set of default meeting parameters or based on an analysis of the content of the email communication itself. For example, the calendar scheduling server 102 may determine the subject of the meeting, a duration of the meeting, and/or an acceptable day and time (i.e., “a time slot”) or range of days/times for the proposed meeting based on the content of the email communication itself. Additionally, in some embodiments, the calendar scheduling server 102 may be configured to determine or adjust the meeting parameters based on user-defined preferences of each participant (e.g., a particular participant may block-out a particular day from all meetings) and/or a user history of each participant (e.g., whether a participant takes lunch at a particular time each day). Of course, the global set of user-defined preferences and/or user histories of the participants may cause conflicts in the scheduling or otherwise be incompatible with each other. In such situations, the calendar scheduling server 102 may be configured to adjust the meeting parameters based on additional criteria, such as a user hierarchy assigned to each participant. For example, a user-defined preference of a participant having a higher user hierarchy (e.g., a team lead) may be weighted higher or satisfied at a higher degree than the user-defined preference of a participant having a lower user hierarchy (e.g., a team member). Of course, the user hierarchy assigned to each participant may be relative to each other such that a particular participant may have different user hierarchies depending on which other participant that particular participant is being compared to. For example, a middle management participant may have a high user hierarchy relative to a new employee but have a low user hierarchy relative to a company executive.

After the calendar scheduling server 102 has determined the meeting participants and meeting parameters, the calendar scheduling server 102 analyzes the digital calendars of each participant to determine a time slot (i.e., a day, time, and duration) on each digital calendar that satisfies the identified meeting parameters. If the calendar scheduling server 102 does not presently have access to the digital calendar of a particular participant, the calendar scheduling server 102 may send an email correspondence to that participant requesting that they link (i.e., provide access to) their digital calendar to the calendar scheduling server 102 or may offer the user to manage their digital calendar directly on the calendar scheduling server 102. After the calendar scheduling server 102 has identified an available time slot on each participant's digital calendar that satisfies the meeting parameters, the calendar scheduling server 102 sends an invite for a meeting at that identified time slot to each participant so as to automatically schedule the meeting without further effort and/or communication on part of the participants.

Of course, depending on various factors such as the total number of participants, the time of year, and the present number of other scheduled activities, the calendar scheduling server 102 may be unable to identify an available time slot on each participant's digital calendar that satisfies the meeting parameters. For example, one or more participants may have an existing, conflicting meeting that restricts the ability of the calendar scheduling server 102 to schedule the requested meeting such that the requested meeting satisfies the meeting parameters (e.g., within an acceptable time span from the present date). In such situations, the calendar scheduling server 102 may be configured to determine whether a conflicting meeting on one or more participant's digital calendar can be adjusted. For example, the calendar scheduling server 102 may determine whether the conflicting meeting can be rescheduled or overbooked (i.e., whether the new meeting can be scheduled at the same time as the existing, conflicting meeting). To do so, the calendar scheduling server 102 may determine characteristics of the conflicting meeting (e.g., the subject matter of conflicting meeting, the participant size of the conflicting meeting, the location of the conflicting meeting, etc.) and/or characteristics of the participant having the conflicting meeting (e.g., user-defined preferences, user history, user hierarchy, etc.), each of which may be considered by the calendar scheduling server 102 in determining whether a particular conflicting meeting can be rescheduled/overbooked. If the calendar scheduling server 102 determines that the conflicting meeting can be rescheduled or overbooked, the calendar scheduling server 102 attempts to adjust the conflicting meeting accordingly. That is, the calendar scheduling server 102 may “automatically” rescheduled the conflicting meeting by moving it to an available time slot on that participant's digital calendar or overbook the conflicting meeting by scheduling the new meeting over that conflicting meeting. In either case, the calendar scheduling server 102 may communicate with the affected participant to obtain their approval and/or inform them of the adjustment. In this way, the calendar scheduling server 102 is configured to provide an automated scheduling solution to users of the system 100 that is capable of identifying time slots on digital calendars of identified participants by rescheduling or overbooking existing, conflicting meetings as needed.

The calendar scheduling server 102 may be embodied as any type of computation or computer device capable of performing the functions described herein, including, without limitation, a server, a rack-mounted server, a blade server, a workstation, a network appliance, a web appliance, a desktop computer, a laptop computer, a tablet computer, a smartphone, a consumer electronic device, a distributed computing system, and/or a multiprocessor system. Additionally, in some embodiments, the calendar scheduling server 102 may be embodied as a “virtual server” formed from multiple computing devices distributed across the network 106 and operating in a public or private cloud. Accordingly, although the calendar scheduling server 102 is illustrated in FIG. 1 as embodied as a single computing device, it should be appreciated that the calendar scheduling server 102 may be embodied as multiple devices cooperating together to facilitate the functionality described below.

As shown in FIG. 1, the illustrative calendar scheduling server 102 includes compute circuitry 120, an I/O subsystem 126, a data storage device 128, and a communication subsystem 130. Of course, the calendar scheduling server 102 may include other or additional components, such as those commonly found in a typical server or other computer (e.g., various input/output devices), in other embodiments. Additionally, in some embodiments, one or more of the illustrative components may be incorporated in, or otherwise form a portion of, another component.

The compute circuitry 120 may be embodied as any type of device or collection of devices capable of performing various compute functions. In some embodiments, the compute circuitry 120 may be embodied as a single device such as an integrated circuit, an embedded system, a field-programmable-array (FPGA), a system-on-a-chip (SOC), or other integrated system or device. Additionally, in some embodiments, the compute circuitry 120 includes or is embodied as a processor 122 and memory 124. The processor 122 may be embodied as any type of processor capable of performing the functions described herein. For example, the processor 122 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the calendar scheduling server 102 such as operating systems, applications, programs, libraries, and drivers.

The compute circuitry 120 is communicatively coupled to other components of the calendar scheduling server 102 via the I/O subsystem 126, which may be embodied as circuitry and/or components to facilitate input/output operations with compute circuitry 120 (e.g., with the processor 122 and/or memory 124) and other components of the calendar scheduling server 102. For example, the I/O subsystem 126 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 126 may be incorporated, along with the processor 122, the memory 124, and other components of the calendar scheduling server 102, into the compute circuitry 120.

The data storage device 128 may be embodied as any type of device or devices configured for short-term or long-term storage of data such as, for example, memory devices and circuits, memory cards, hard disk drives, solid-state drives, or other data storage devices. The communication subsystem 130 of the calendar scheduling server 102 may be embodied as any communication circuit, device, or collection thereof, capable of enabling communications between the calendar scheduling server 102 and the user computer devices 104 over the network 106. The communication subsystem 130 may be configured to use any one or more communication technology (e.g., wireless or wired communications) and associated protocols (e.g., Ethernet, Bluetooth®, Bluetooth Low Energy (BLE), Wi-Fi®, WiMAX, 3G LTE, 5G, etc.) to effect such communication.

Each user computer device 104 may be embodied as any type of computer device capable of performing the functions described herein. For example, the user computer device 104 may be embodied as, without limitation, a smartphone, a mobile computing device, a computer, a laptop computer, a notebook computer, a tablet computer, a wearable computing device, a processor-based system, and/or a consumer electronic device. In the illustrative embodiment, each user computer device 104 is embodied as a personal computer device on which the respective user may maintain a personal digital calendar, in some embodiments. The personal digital calendar may be stored locally on the user computer device 104 or on another computer device (e.g., the calendar scheduling server 102 or a third-party server) of the system 100.

As shown in FIG. 1 and similar to the calendar scheduling server 102, each user computer device 104 includes compute circuitry 150, an I/O subsystem 156, an output device 158, and a communication subsystem 160. Of course, each user computer device 104 may include other or additional components, such as those commonly found in a mobile computer device (e.g., short and/or long term data storage), in other embodiments. Additionally, in some embodiments, one or more of the illustrative components may be incorporated in, or otherwise form a portion of, another component.

The compute circuitry 150 may be embodied as any type of device or collection of devices capable of performing various compute functions. In some embodiments, the compute circuitry 150 may be embodied as a single device such as an integrated circuit, an embedded system, a field-programmable-array (FPGA), a system-on-a-chip (SOC), or other integrated system or device. Additionally, in some embodiments, the compute circuitry 150 includes or is embodied as a processor 152 and memory 154. The processor 152 may be embodied as any type of processor capable of performing the functions described herein. For example, the processor 152 may be embodied as a single or multi-core processor(s), digital signal processor, microcontroller, or other processor or processing/controlling circuit. Similarly, the memory 154 may be embodied as any type of volatile or non-volatile memory or data storage capable of performing the functions described herein. In operation, the memory 154 may store various data and software used during operation of the respective user computer device 104 such as operating systems, applications, programs, libraries, and drivers.

The compute circuitry 150 is communicatively coupled to other components of the respective user computer device 104 via the I/O subsystem 156, which may be embodied as circuitry and/or components to facilitate input/output operations with compute circuitry 150 (e.g., with the processor 152 and/or memory 154) and other components of the respective user computer device 104. For example, the I/O subsystem 156 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 156 may be incorporated, along with the processor 152, the memory 154, and other components of the respective user computer device 104, into the compute circuitry 150.

The output device(s) 158 may be embodied as any type of output device capable of presenting an output or information to the user of the respective user computer device 104. For example, in the illustrative embodiment, the output device 158 is embodied as be embodied as, or otherwise include, a visual output device such as a display screen.

The communication subsystem 160 of the respective user computer device 104 may be embodied as any communication circuit, device, or collection thereof, capable of enabling communications between the respective user computer device 104, the calendar scheduling server 102, and/or other computer devices of the system 100. The communication subsystem 160 may be configured to use any one or more communication technology (e.g., wireless or wired communications) and associated protocols (e.g., Ethernet, Bluetooth®, Bluetooth Low Energy (BLE), Wi-Fi®, WiMAX, 3G LTE, 5G, etc.) to effect such communication.

As discussed in more detail below, the calendar scheduling server 102 is configured to communicate with each of the user computer devices and/or other devices of the system 100 over the network 106. The network 106 may be embodied as any number of various wired and/or wireless networks. For example, the network 106 may be embodied as, or otherwise include, a wired or wireless local area network (LAN), a wired or wireless wide area network (WAN), a cellular network, and/or a publicly-accessible, global network such as the Internet. As such, the network 106 may include any number of additional devices, such as additional computers, routers, stations, and switches, to facilitate communications among the devices of the system 100.

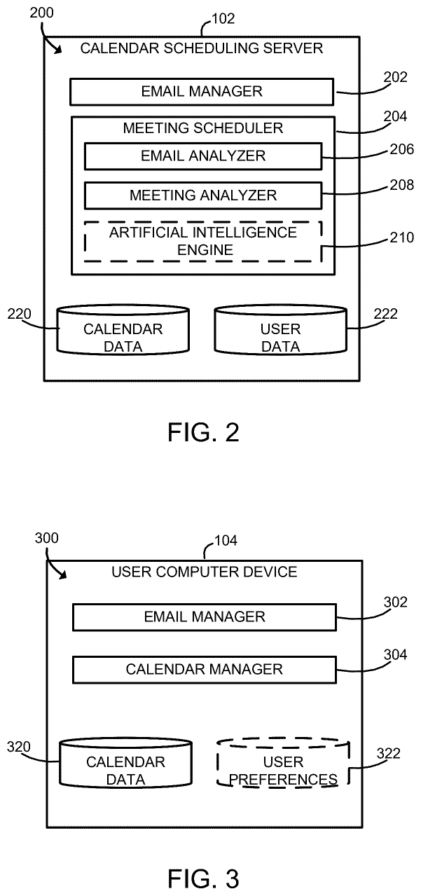

Referring now to FIG. 2, in the illustrative embodiment, the calendar scheduling server 102 is configured to establish an environment 200 during operation. The illustrative environment 200 includes an email manager 202, a meeting scheduler 204, and various data sets including, for example, calendar data 220 and user data 222. The various components of the environment 200 may be embodied as hardware, firmware, software, or a combination thereof. As such, in some embodiments, one or more of the components of the environment 200 may be embodied as circuitry or a collection of electrical devices (e.g., email manager circuitry 202, meeting scheduler circuitry 204, etc.) It should be appreciated that, in such embodiments, one or more of those components may form a portion of the processor 122, the I/O subsystem 126, and/or other components of the calendar scheduling server 102.

The email manager 202 is configured to manage the email communications received from and sent to the user computer devices 104. That is, the email manager 202 receives the initial email from the “host” user, which includes an indicator that indicates a desire by the sender to schedule the meeting. For example, in the illustrative embodiment, the indicator may be embodied as the inclusion of a particular email address monitored or otherwise managed by the calendar scheduling server 102 in the recipient list of the email (e.g., as a carbon copied recipient). In other embodiments, the indicator may be embodied as a key phrase or code, which may be included in the subject line or the content of the email. If the email manager 202 detects the indicator in the received email, the email manager 202 is configured to pass that email along to the meeting scheduler 204 for analysis. The email manager 202 also manages outgoing email from the calendar scheduling server 102 to, for example, schedule the determined meeting, confirm the availability of a participant, and/or otherwise communicate with the user computer devices 104.

The meeting scheduler 204 is configured to analyze the received email including the indicator that indicates a desire by the sender to schedule a meeting and schedule the meeting with the desired participants. To do so, the meeting scheduler 204 includes an email analyzer 206 configured to analyze the received email to determine the set of participants that should be included in the meeting and a set of meeting parameters. The email analyzer 206 may determine the set of participants using any suitable methodology. For example, in some embodiments, the email analyzer 206 may analyze the email to determine the sender and other recipients of the email communication, analyze the body of the email to identify participants referenced in the email, and/or by infer the participants of the meeting based on the content of the email communication, user preferences, user history, and/or other considerations.

The email analyzer 206 is also configured to analyze the received email to determine a set of meeting parameters that the requested meeting should satisfy. As discussed above, the meeting parameters define characteristics (e.g., meeting subject, meeting duration, meeting day and time, etc.) that should be embodied by the scheduled meeting. The email analyzer 206 may determine the meeting parameters using any suitable methodology and associated data. For example, in some embodiments, the email analyzer 206 may determine the meeting parameters based on a pre-defined set of default meeting parameters, which may be universally- or user-defined. Additionally or alternatively, the email analyzer 206 may determine the meeting parameters based on the content of the email communication received from the “host.” For example, the email analyzer 206 may analyze conversations included the body of the email to determine or infer the meeting parameters. Furthermore, in some embodiments, the email analyzer 206 may determine or adjust the meeting parameters based on user-defined preferences of each participant and/or upon a user history associated with each participant, which may be stored in the user data 222. For example, a participant may establish a user-defined preference not to have meeting before and/or after a certain time of the day, to limit the meeting duration to maximum length, to be included or not included on meetings based on the subject matter of the meeting, etc. Additionally or alternatively, the user history may indicate a preference for early or late meetings, meetings on or not on a certain day, and or meetings spaced from each other by a particular amount of time. As mentioned above, the user-defined preferences and/or user histories of the participants of the meeting may be incompatible with each other and, in such cases, the email analyzer 206 may be configured to weigh each user-defined preference and/or user history based on a user hierarchy assigned to that particular user. That is, the email analyzer 206 may attempt to satisfy or match the user preferences and/or user histories of participants having a higher user hierarchy before attempting to satisfy or match the user preferences and/or user histories of participants having a lower user hierarchy. Again, as discussed above, the user hierarchies may be relative to each other, and any single participant may have multiple user hierarchy scores based on the participant to whom that particular participant is being compared. The user hierarchies may be assigned globally or by each participant. Additionally, in some embodiments, the calendar scheduling server 102 may be configured to infer or learn user hierarchies over time by, for example, analyzing email communications between users, analyzing company rosters, and/or other suitable methodologies.

The meeting scheduler 204 also includes a meeting analyzer 208 configured to analyze the digital calendars of each participant to determine a time slot available on each participant's calendar that satisfies the identified meeting parameters. In some embodiments, the digital calendar of each participant is stored and managed locally on the calendar scheduling server 102 in the calendar data 220. In other embodiments, the digital calendar of each participant may be linked to the calendar scheduling server 102 and accessible by the meeting analyzer 208. After the meeting analyzer 208 identifies an available time slot of each participant's digital calendar, the email manager 202 generates a meeting invite that is sent to each identified participant for a meeting at the identified time slot.

However, as discussed above, the meeting analyzer 208 may encounter a conflicting meeting on a digital calendar of one or more participants that limits the ability of the meeting analyzer 208 to schedule a meeting that satisfies the meeting parameters. In such circumstances the meeting analyzer 208 is configured to determine whether the conflicting meeting can be adjusted. For example, the meeting analyzer 208 may determine whether the conflicting meeting can be rescheduled or overbooked. To do so, as discussed above, the meeting analyzer 208 may consider characteristics of the conflicting meeting and/or or characteristics of the participant having the conflicting meeting to determine whether the conflicting meeting can be rescheduled/overbooked. If the meeting analyzer 208 determines that the conflicting meeting can be rescheduled or overbooked, the meeting analyzer 208 attempts to adjust the conflicting meeting accordingly by automatically rescheduling the conflicting meeting or scheduling the new meeting over the conflicting meeting. To do so, the meeting analyzer 208 may interface with the email manager 202 to request authorization to reschedule and/or overbook the conflicting meeting from the respective participant.

In some embodiments, the meeting scheduler 204 may include an artificial intelligence engine 210 configured to support the analysis of emails, the scheduling of meetings, and the adjustment (e.g., rescheduling or overbooking) of identified conflicting meetings. The artificial intelligence engine 210 may utilize any type of suitable artificial intelligence including for example, natural language processing, machine learning, deep learning, and/or neural networks. For example, the email analyzer 206 may use the artificial intelligence engine 210 to determine the user preferences and/or user history with direct human interaction. Additionally or alternatively, the meeting analyzer 208 may utilize the artificial intelligence engine 210 to determine whether a conflicting meeting of a participant's digital calendar may be rescheduled or overbooked based on a learned behavior or preference of the particular participant.

Referring now to FIG. 3, in the illustrative embodiment, each user computer device 104 is configured to establish an environment 300 during operation. The illustrative environment 300 includes an email manager 302, a calendar manager 304, and various data sets including, for example, calendar data 320 and user preferences 322. The various components of the environment 300 may be embodied as hardware, firmware, software, or a combination thereof. As such, in some embodiments, one or more of the components of the environment 300 may be embodied as circuitry or a collection of electrical devices (e.g., email manager circuitry 302, calendar manager circuitry 304, etc.) It should be appreciated that, in such embodiments, one or more of those components may form a portion of the processor 152, the I/O subsystem 156, and/or other components of the respective user computer device 104.

The email manager 302 is configured to manage the email communications received from and sent to the calendar scheduling server 102. For example, the email manager 302 may facilitate response to emails from the calendar scheduling server 102 requesting confirmation of a scheduled meeting. Additionally, the email manager 302 may interface with the calendar manager 304 to provide access by calendar scheduling server 102 to the calendar data 320 of the user stored locally on the user computer device 104.

The calendar manager 304 is configured to manage the local digital calendar of the user, which may be stored in the calendar data 320, and/or a remote digital calendar maintained by a third-party service (e.g., a third-party email service). In use, the calendar manager 304 is configured to schedule a meeting on the user's digital calendar based on receipt and acceptance of a meeting invite received from the calendar scheduling server 102. Additionally, the calendar manager 304 may allow the user of the user computer device 104 to manually schedule, remove, and/or adjust digital meetings scheduled on the user's digital calendar. In some embodiments, the calendar manager 304 may be embodied as an application provided and maintained by the calendar scheduling server 102 to facilitate use of the automated scheduling services provided by the calendar scheduling server 102.

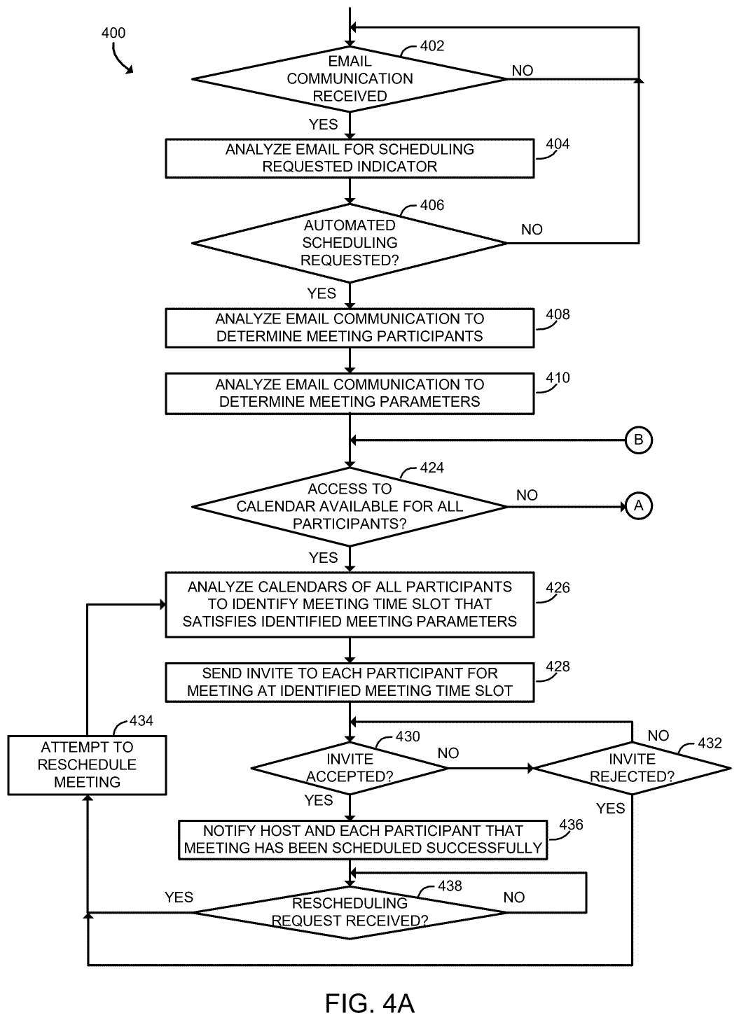

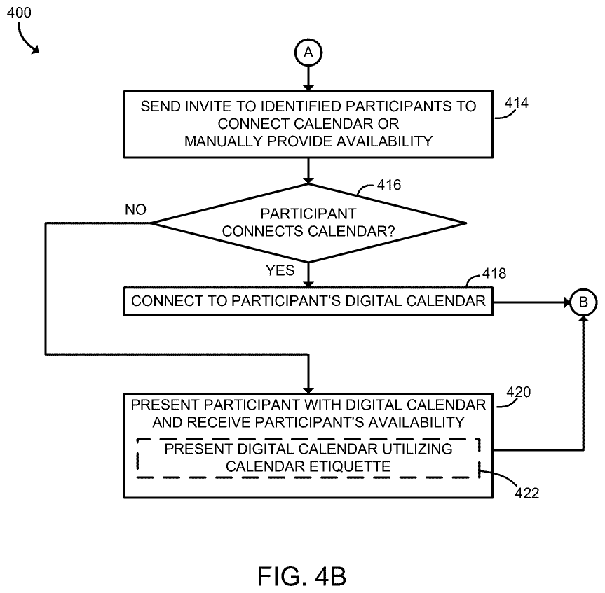

Referring now to FIG. 4, in use, the calendar scheduling server 102 may execute a method 400 for automated scheduling of a meeting. It should be appreciated that, in some embodiments, the operations of the method 400 may be performed by one or more components of the environment 200 of the calendar scheduling server 102 as shown in FIG. 2.

The method 400 begins with block 402, in which the calendar scheduling server 102 determines whether an email communication has been received from one of the user computer devices 104 of the system 100. If so, the method 400 advances to block 404 in which the calendar scheduling server 102 analyzes the received email communication to determine whether the email communication includes a scheduling requested indicator that indicates a desire by the sender of the email communication to schedule a meeting. In the illustrative embodiment, the scheduling requested indicator is embodied as a carbon copy of an email address monitored by the calendar scheduling server 102. That is, a user of one of the user computer devices 104 may request the automated scheduling of a meeting by carbon copying the email address monitored by the calendar scheduling server 102. In other embodiments, however, other types of indicators of a desire to schedule a meeting may be used. For example, the email communication may include a direct instruction in the body of the email or the subject line, or the calendar scheduling server 102 may infer the desire to schedule a meeting based on the context of the email itself (e.g., by using natural language processing to understand the context and desire to schedule the meeting from the language used in the email communication).

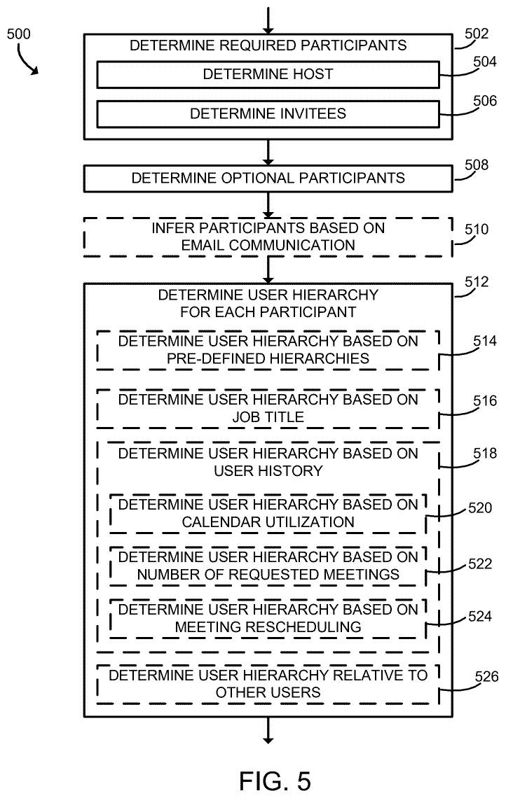

If, in block 406, the calendar scheduling server 102 determines that a request to schedule a meeting was not included in the received email communication, the method 400 loops back to block 402 in which the calendar scheduling server 102 continues to monitor for additional email communications. However, if the calendar scheduling server 102 determines, in block 406, that automated scheduling of a meeting was requested, the method 400 advances to block 408. In block 408, the calendar scheduling server 102 analyzes the email communication to determine the set of participants for the meeting. To do so, the calendar scheduling server 102 may utilize any suitable methodology and associated data. For example, in the illustrative embodiment, the calendar scheduling server 102 executes a method 500 for determining meeting participants as shown in FIG. 5.

The method 500 beings with block 502 in which the calendar scheduling server 102 determines the set of required participants. For example, in block 504, the calendar scheduling server 102 determines the host of the meeting, which is defined as the sender of the email communication including the scheduling requested indicator. Additionally, in block 506, the calendar scheduling server 102 determines additional invitees to the meeting. To do so, the calendar scheduling server 102 may analyze the other recipients of the email communication and determine those recipients are invitees to the requested meeting. Additionally or alternatively, the calendar scheduling server 102 may analyze the email communication to identify any additional participant referenced in the body of the email. For example, the body of the email communication may include a suggestion to invite a particular participant who was not included as a recipient of the email communication. In such embodiments, the calendar scheduling server 102 would determine that the mentioned participant should be designated as an invitee to the requested meeting.

In block 508, the calendar scheduling server 102 also determines any optional participants of the meeting. In some embodiments, the optional participants may be identified in the email communication specifically as optional attendees (e.g., in the recipient header). In other embodiments, the calendar scheduling server 102 may determine optional participants based on an analysis of the body of the email. Additionally, in some embodiments in block 510, the calendar scheduling server 102 may infer participants to be included in the meeting based on the email communication. That is, the calendar scheduling server 102 may be configured to analyze the language of the email communication (e.g., by using the artificial intelligence engine 210) to infer one or more additional participants to invite to the meeting. Such analysis may include a review of user preferences and/or user history. For example, if a particular participant has always been invited to a meeting having the same subject or including the same set of participants, the calendar scheduling server 102 may infer that that participant should be invited to the newly-requested meeting as well. Of course, the calendar scheduling server 102 may be configured to confirm the inferred participants with the host of the meeting prior to including those inferred participants in the scheduled meeting.

Subsequently, in block 512, the calendar scheduling server 102 determines a user hierarchy for each identified participant. To do so, the calendar scheduling server 102 may use any suitable methodology for determining user hierarchies. As discussed above, the user hierarchy provides a relative ranking of “importance” of the participants, which may be used by the calendar scheduling server 102 in subsequent analysis (e.g., when determining whether to reschedule or overbook a meeting). In some embodiments, in block 514, the calendar scheduling server 102 may determine a user hierarchy for each participant based on pre-define hierarchies. For example, the user hierarchy scores may be pre-defined for each user (e.g., assigned at time of employment) and/or maintained over subsequent iterations of the method 400.

Additionally or alternatively, in block 516, the calendar scheduling server 102 may determine a user hierarchy for one or more of the participants based on a job title associated with that respective participant. In such embodiments, for example, the calendar scheduling server 102 may assign a higher user hierarchy for executive-level employees relative to non-executive level employees, a higher user hierarchy to team leads relative to team members, and so forth. In some embodiments, the calendar scheduling server 102 may be configured to determine the user hierarchy of one or more participants using publicly available databases, data repositories, and/or other data sources. For example, the calendar scheduling server 102 may be configured to search social media accounts (e.g., Linkedin®, Facebook®, etc.) of the participants to determine a job title and associated user hierarchy for the participants.

In some embodiments, in block 518, the calendar scheduling server 102 may determine a user hierarchy for one or more of the participants based on a user history associated with that particular participant. In doing so, the calendar scheduling server 102 may be configured to utilize any suitable user-related information. For example, in block 520, the calendar scheduling server 102 may be configured to determine a participant's user hierarchy based on a utilization of the participant's calendar. That is, participants having a larger hourly commitment to meetings (e.g., 40 hours' worth of meeting in a rolling month) may be determined to have a higher user hierarchy than participants having fewer hourly commitments to meetings.

In block 522, the calendar scheduling server 102 may be configured to determine a participant's user hierarchy based the number of requested meetings that participant receives within a defined period time. For example, participants that receive a larger number of meeting requests over a week or month period may be determined to have a higher user hierarchy than participants that receive fewer meeting requests over that same time period.

Additionally, in block 524, the calendar scheduling server 102 may be configured to determine a participant's user hierarchy based on the nature under which meetings are rescheduled based on that participant's availability. For example, if the calendar scheduling server 102 determines meetings are often reschedule if a particular participant cannot attend that meeting, the calendar scheduling server 102 may determine that that particular participant has a relative high user hierarchy. Conversely, if the calendar scheduling server 102 determines meetings typically proceed even if a particular participant cannot attend that meeting, the calendar scheduling server 102 may determine that that particular participant has a relative low user hierarchy.

Furthermore, in some embodiments in block 526, the calendar scheduling server 102 may determine the user hierarchies relative to each other participant. That is, as discussed above, the user hierarchy assigned to each participant by calendar scheduling server 102 may be relative to each other. In this may, each participant may be assigned a pool of different user hierarchies depending on which other participant that particular participant is being compared to.

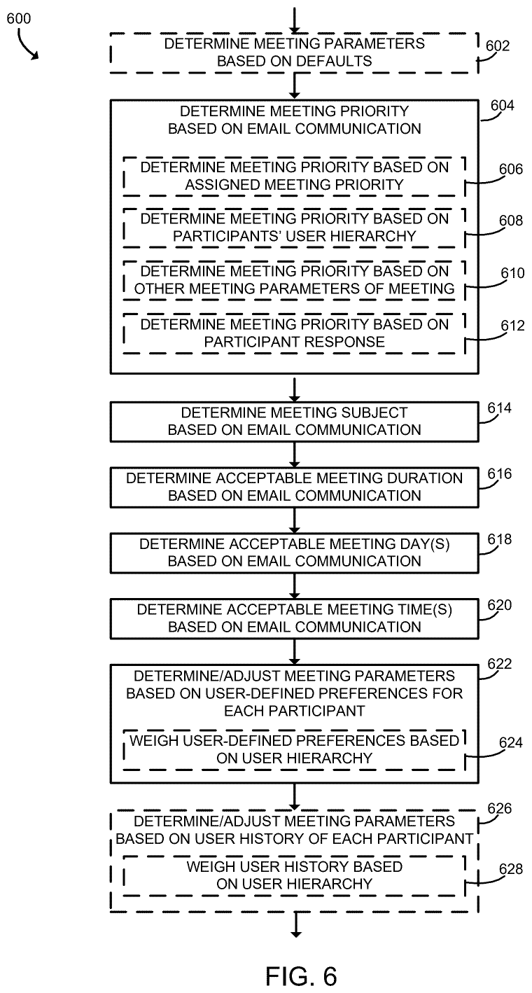

Referring back to FIG. 4, after the calendar scheduling server 102 has determined the meeting participants in block 408, the method 400 advances to block 410 in which the calendar scheduling server 102 analyzes the email communication to determine a set of meeting parameters that the to-be-scheduled meeting should satisfy. The meeting parameters may be embodied as any criteria that defines a characteristic of the requested meeting, such as the meeting hierarchy, the meeting subject, the meeting duration, the meeting day, the meeting time, the maximum time in which the meeting should be scheduled, etc. To determine the meeting parameters, the calendar scheduling server 102 may execute a method 600 for determining meeting parameters as shown in FIG. 6.

The method 600 begins with block 602 in which the calendar scheduling server 102 may, in some embodiments, set the meeting parameters to default meeting parameters. Such default meeting parameters may be globally-defined parameters (e.g., apply to every meeting, be based on a company-wide preference), user-defined parameters (e.g., default parameters that are defined by a particular participant), or other types of default parameters. In the illustrative embodiment, however, the calendar scheduling server 102 is configured to determine or otherwise update one or more meeting parameters based on the email communication itself. For example, the host participant may identify the meeting parameters (e.g., the meeting priority) when sending the email communication. Additionally or alternatively, the calendar scheduling server 102 may analyze the language and/or context of the header and/or body of the email and determine or modify (e.g., if initially based on a default parameter) the meeting parameters.

In block 604, the calendar scheduling server 102 may determine or otherwise modify a meeting priority parameter based on the email communication. For example, in block 606, the calendar scheduling server 102 may determine the meeting priority based on a meeting priority that is assigned by the host participant in the email communication itself (e.g., a “hard coded” meeting priority). That is, the host may flag or otherwise indicate that the requested meeting should be considered of a certain priority. Additionally or alternatively, the calendar scheduling server 102 may infer the meeting priority in block 606 based on the language or context of the email communication (e.g., based on keywords such as “urgent” or “asap” appearing in the email communication).

In some embodiments, in block 608, the calendar scheduling server 102 may determine the meeting priority based on the user hierarchy of one or more identified participants. In doing so, the calendar scheduling server 102 may utilize any suitable methodology for determine the meeting priority based on user hierarchies. For example, the calendar scheduling server 102 may determine the meeting priority based on, or as a function of, the highest user hierarchy score of the participants (e.g., if the requested meeting includes the Chief Executive Officer of a company as a participant, the calendar scheduling server 102 may determine that such a meeting has a high meeting priority). Additionally or alternatively, the calendar scheduling server 102 may determine the meeting priority based on an average hierarchy of the participants, based on the user hierarchy of the identified host, and/or based on another combination of user hierarchies.

Additionally, in some embodiments, the calendar scheduling server 102 may determine the meeting priority based on other meeting parameters in block 610. For example, the meeting priority may be based on the meeting subject (see, e.g., discussion of block 614 below), based on the duration of the requested meeting (see, e.g., discussion of block 616 below), or based on the meeting day/time (see, e.g., discussion of blocks 618 and 620 below). For example, the calendar scheduling server 102 may be configured to determine that requested meetings have a longer duration or requested to occur sooner in time have a higher meeting priority.

In some embodiments in block 612, the calendar scheduling server 102 may additionally or alternatively determine or adjust the meeting priority based on a participant response to the requested meeting. For example, if one or more participants manually adjust their availability or reschedule another meeting to ensure availability for the requested meeting, the calendar scheduling server 102 may determine that the requested meeting is of a higher priority.

In addition to the meeting priority, the calendar scheduling server 102 may be configured to determine or modify other meeting parameters. For example, in block 614, the calendar scheduling server 102 may determine or otherwise modify a meeting subject parameter based on the email communication. To do so, the calendar scheduling server 102 may determine the meeting subject parameter based on the language provided in the subject line of the email commination and/or on context of the body of the email communication. In block 616, the calendar scheduling server 102 may determine or otherwise modify an acceptable meeting duration parameter based on the email communication. Again, the calendar scheduling server 102 may determine the meeting duration parameter based on the language or context of the body of the email communication (e.g., a specific meeting duration may be mentioned in the email or the calendar scheduling server 102 could infer a meeting duration based on the subject of the meeting). In blocks 618 and 620, the calendar scheduling server 102 may determine or otherwise modify an acceptable meeting day(s) and/or time(s) parameters (i.e., an acceptable meeting “timeslot”) based on the email communication. For example, the calendar scheduling server 102 may determine the meeting day and time parameters based on the language or context of the body of the email communication (e.g., a specific day and/or time may be discussed in the email).

In some embodiments, in block 622, the calendar scheduling server 102 may determine or adjust one or more meeting parameters based on user-defined preferences for each participant of the meeting. That is, each participant may specify a set of user preferences that define or otherwise affect one or more meeting parameters. For example, a particular user may specify that he/she is unavailable on a particular day, does not accept meetings before a particular time of the day, can only meet at a certain location, is uninterested in meetings regarding a certain subject, only meets for a defined maximum duration, and so forth. Those user-defined preferences may be stored locally on each participant's user computer device 104 (e.g., in user preferences data 322) and/or by the calendar scheduling server 102 itself (e.g., in the user data 222).

In determining the set of meeting parameters, the calendar scheduling server 102 may collate and consider the user-defined preferences from each participant. It should be appreciated, however, that the collected, global set of user-defined preferences may present scheduling conflicts or otherwise be incompatible with each other. In such situations, the calendar scheduling server 102 may be configured to apply a weight factor to each user-defined preference in block 624. The particular weight factor applied to a particular user-defined preference may vary based on any number and type of criteria. For example, in the illustrative embodiment, the weight factor may be determined based on the relevant user hierarchy. Additionally or alternatively, the weight factor may be determined based on the particular type of user-defined preference (e.g., an availability preference may be weighed more than a duration preference).

In some embodiments, in block 626, the calendar scheduling server 102 may also determine or adjust one or more meeting parameters based on the user history of each participant of the meeting. That is, calendar scheduling server 102 may monitor each participant's interaction with meetings and adjust the meeting parameters based on such interaction history. For example, the calendar scheduling server 102 may determine that a particular participant typically does not accept meetings after a certain time of day or on a certain day and, if so, the calendar scheduling server 102 may update the meeting parameters to ensure the scheduled meeting does not occur after that time of day or on that certain day. The calendar scheduling server 102 may monitor or track user history using the artificial intelligence engine 210 and store the user history data in the user data 222, for example.

Again, in determining the set of meeting parameters, the calendar scheduling server 102 may collate and consider the user histories of each participant. As such, it should be appreciated, that the collected, global set of user histories may present scheduling conflicts or otherwise be incompatible with each other. Similar to the user-defined preferences, the calendar scheduling server 102 may be configured to apply a weight factor to each user history in block 62, which may vary based on any number and type of criteria. For example, in the illustrative embodiment, the weight factor may be determined based on the based on the relevant user hierarchy and/or the freshness of user history (e.g., more recent user activity may be weighed more than old user activity).

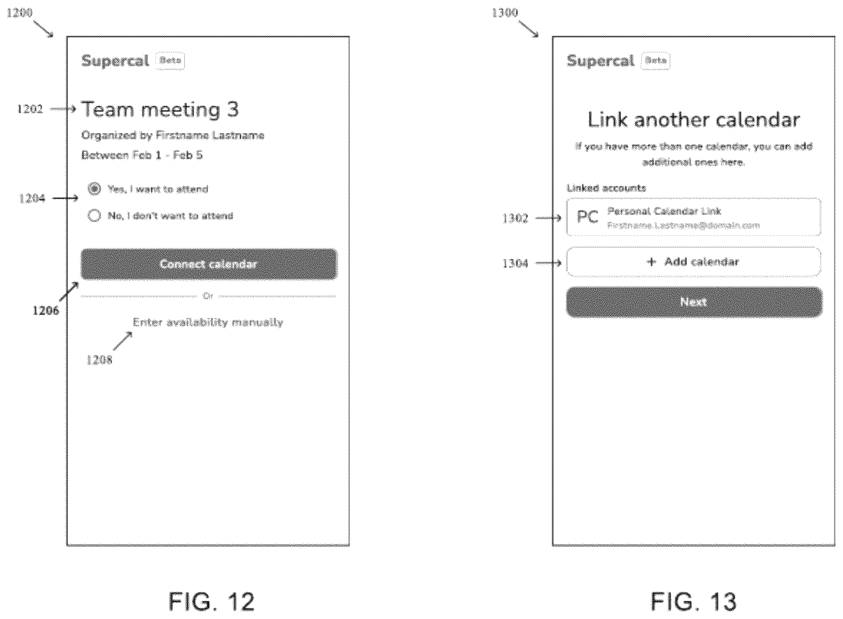

Referring back to FIG. 4, after the calendar scheduling server 102 has determined the meeting parameters in block 410, the method 400 advances to block 412 in which the calendar scheduling server 102 determines whether access to the digital calendar of each meeting participant is available. As discussed above, the digital calendar may be maintained individually by each participant on their respective user computer device 104 or via a third-party application and/or may be maintained by the calendar scheduling server 102 itself. If the calendar scheduling server 102 determines that access to one or more meeting participant's digital calendar is not available, the method 400 advances to block 414 of FIG. 4B in which the calendar scheduling server 102 transmits an invite to the identified participant(s) to either connect or “link” their individual digital calendar to the calendar scheduling server 102 or to manually provide their availability on a digital calendar maintained by the calendar scheduling server 102. For example, as shown in FIG. 12, the calendar scheduling server 102 may present a user interface 1200 to the participant on the participant's user computer device 104. The user interface 1200 includes meeting parameter indicia 1202, which illustratively includes the name or subject matter of the proposed meeting, the name of the host, and a suggested date range for the proposed meeting. The user interface 1200 also includes selection buttons 1204, which the receiving participant can select to provide their intention to attend or not to attend. Additionally, the user interface 1200 includes a selection link 1206 that the participant can select to connect their own digital calendar to the calendar scheduling server 102 and a selection link 1208 that the participant can select to manually supply their availability using a digital calendar maintained by the calendar scheduling server 102 as discussed below.

Referring back to FIG. 4B, if the user determines to connect their own digital calendar in block 416 (e.g., by selection of the selection link 1206), the method 400 advances to block 418 in which the calendar scheduling server 102 connects to the participant's digital calendar. In doing so, the calendar scheduling server 102 may present a user interface 1300 to the participant on the participant's user computer device 104 as shown. As shown in FIG. 13, the illustrative user interface 1300 includes an indicia 1302 of the linked or connected, personal digital calendars of that participant. Additionally, the participant can add additional personally-maintained digital calendar via selection of a link 1304. Once the participant's digital calendar is linked in this manner, the calendar scheduling server 102 can analyze that participant's calendar or calendars as discussed below.

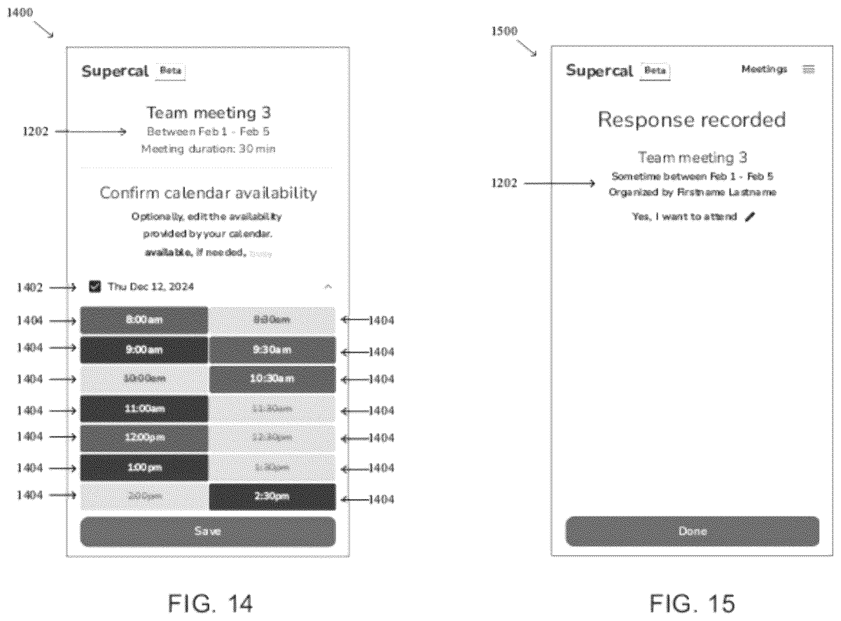

Referring again back to FIG. 4B, if the participant decides not to connect or link their digital calendar to the calendar scheduling server 102 in block 416 (e.g., via selection of selection link 1208), the method 400 advances to block 420. In block 420, the calendar scheduling server 102 presents that participant with a digital calendar that is maintained by the calendar scheduling server 102. The participant may then provide their availability directly on the calendar maintained by the calendar scheduling server 102. For example, as shown in FIG. 14, the calendar scheduling server 102 may present a user interface 1400 to the participant on the participant's user computer device 104, which includes the meeting parameter indicia 1202 that identifies the requested meeting and a digital calendar 1402. As discussed above, the digital calendar 1402 is maintained by the calendar scheduling server 102 and includes a set of time blocks 1404, which the user may select to identify their availability. Each time block 1404 may be color coded or emphasized using another visual mechanism capable of indicating the participant's availability. For example, the participant may select individual time blocks 1404 to identify that they are “available,” “not available,” or “available-if-needed.” In response, the calendar scheduling server 102 may update the background color of each time block 1404. For example, “available” time blocks may be displayed with a green background, “not available” time blocks may be displayed with a red background, and “available-if-needed” may be displayed with a yellow background. It should be appreciated, however, that other coloring schemes may be used in other embodiments.

When initially generating and displaying the digital calendar 1402, the calendar scheduling server 102 may utilize a set of “calendar etiquette” (scc, e.g., block 422 of FIG. 4B). The set of “calendar etiquette” may define default parameters of the digital calendar 1402. For example, certain time blocks 1404 may be pre-defined as “available,” “not available,” or “available-if-needed” depending on their particular time coverage, the particular day, user preferences, user hierarchy, user history, meeting priority, etc. For example, in an illustrative embodiment, the calendar scheduling server 102 may identify time blocks 1404 occurring before or after a certain time period (e.g., before 8 AM or after 6 PM on a weekday and all day on a weekend) as “not available” or “available-if-needed,” so as to acknowledge the typical workday of a participant. Additionally, the calendar scheduling server 102 may identify time blocks 1404 that occur immediately before or after a “not available” time block as “available-if-needed” to provide the participant time before or between meetings to prepare and/or attend to other activities (rather than moving from one meeting directly to the next meeting). The remaining time blocks 1404 may be initially marked as “available” (e.g., colored green) by the calendar scheduling server 102. Again, it should be appreciated that the availability initially identified by the calendar scheduling server 102 in each time block 1404 may be modified by the particular participant. For example, although the calendar scheduling server 102 may mark a time block 1404 covering 6 AM as “not available,” the participant may manually update that time block 1404 to show as “available” or “available-if-needed,” based on that participant's availability. The participant may also update time blocks 1404 initially identified as “available” with “not available” or “available-if-needed,” if that participant has another meeting or task to attend to or is otherwise not available during that corresponding time frame. In this way, the calendar scheduling server 102 facilitates the manual entry of a participant's availability without the requirement of a direct connection or link to a personal digital calendar maintained by the participant.

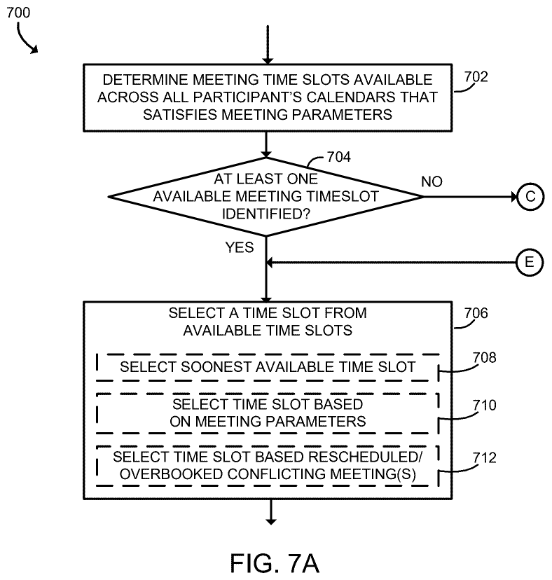

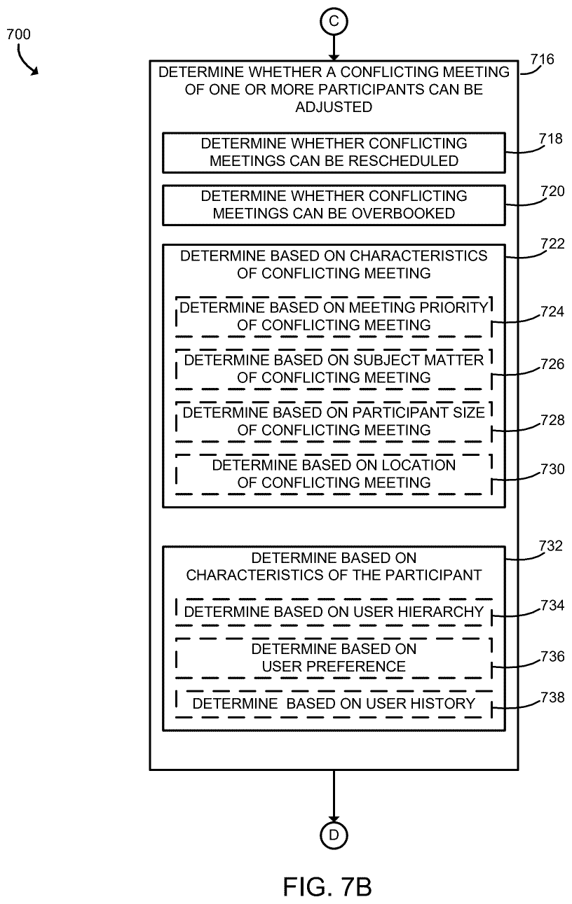

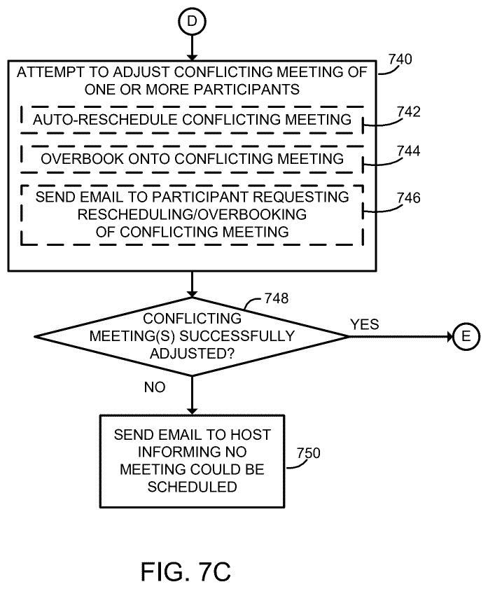

Regardless whether the participant opts to connect their digital calendar or provides their availability on the digital calendar maintained by the calendar scheduling server 102, the calendar scheduling server 102 may provide a notification to the participant that their availability response (either manually provided or inferred from their digital calendar) has been received. For example, as shown in FIG. 15, the calendar scheduling server 102 may present a user interface 1500 to the participant on the participant's user computer device 104. The user interface 1500 includes the meeting parameter indicia 1202 that identifies the requested meeting and confirms receipt of that participant's availability. The method 400 subsequently loops back to block 424 of FIG. 4A. In block 424, the calendar scheduling server 102 determines whether a digital calendar for each participant is available (i.e., either the participant's own digital calendar or a digital calendar maintained by the calendar scheduling server 102). If so, the method 400 advances to block 426 in which the calendar scheduling server 102 analyzes the digital calendars of each meeting participant to identify or determine a meeting time slot (i.e., a meeting day, time, and duration) that satisfies the identified meeting parameters. To do so, the calendar scheduling server 102 may execute a method 700 for determining an available meeting time slot for each meeting participant as shown in FIGS. 7A-7C.

The method 700 begins with block 702 in which the calendar scheduling server 102 determines the global set of meeting time slots that are available across all of the participant's digital calendar and which satisfy the meeting parameters. That is, the calendar scheduling server 102 analyzes the digital calendars of each meeting participant to identify one or more time slots available in each calendar that also satisfies the determined meeting parameters. In bock 704, the calendar scheduling server 102 determines if at least one time slot across the digital calendars of all identified participants was successfully identified. If so, the method advances to block 706.

In block 706, the calendar scheduling server 102 selects a time slot in which to schedule the meeting from the available identified in block 702. If more than one time slot is available for selection, the calendar scheduling server 102 may utilize any suitable methodology to select the time slot from those that are available. For example, in some embodiments in block 708, the calendar scheduling server 102 may select the time slot that is the soonest in time from the present day. Alternatively, in block 710, the calendar scheduling server 102 may select the time slot that best satisfies the meeting parameters. For example, the calendar scheduling server 102 may select the time slot that satisfies the most meeting parameters or the time slot that satisfies the meeting parameters to the greatest degree. Additionally, in some embodiments in block 712, the calendar scheduling server 102 may select the time slot that requires the least number or degree of rescheduling or overbooking of conflicting meetings as discussed in more detail below.

Referring back to block 704, if the calendar scheduling server 102 is unable to identify at least one time slot available in each participant's calendar that also satisfies the determined meeting parameters, the method 700 advances to block 716 of FIG. 7B. In block 716, the calendar scheduling server 102 determines whether a conflicting meeting identified on the digital calendar of one or more participants can be adjusted. That is, the inability of the calendar scheduling server 102 to determine at least one available time slot across the participant's calendars is typically due to one or more conflicting meetings. As such, in block 718, the calendar scheduling server 102 may determine whether each conflicting meeting can be rescheduled on that particular participant's digital calendar. The rescheduling of a conflicting meeting involves moving the conflicting meeting to a different time slot on that participant's calendar (and on the corresponding digital calendar of any additional participants of that conflicting meeting). For example, the conflicting meeting may be moved to a different time and/or day.

Additionally or alternatively, in block 720, the calendar scheduling server 102 may determine whether each conflicting meeting can be overbook on that particular participant's digital calendar. The overbooking of a conflicting meeting involves scheduling the requested meeting during at least a portion of the day and time at which the conflicting meeting occurs such that the two meeting overlap to some degree. It should be appreciated that the calendar scheduling server 102 may first attempt to reschedule a conflicting meeting and then attempt to overbook that conflicting meeting if the calendar scheduling server 102 is unable to reschedule it or vice versa.

The calendar scheduling server 102 may utilize any suitable methodology to attempt to reschedule or overbook a conflicting meeting on a participant's digital calendar. In some embodiments, the calendar scheduling server 102 may attempt to reschedule or overbook a conflicting meeting based on characteristics of the conflicting meeting in block 722. In doing so, the calendar scheduling server 102 may consider any type of characteristic of the conflicting meeting. For example, in block 724, the calendar scheduling server 102 may determine whether a conflicting meeting can be rescheduled or overbooked based on the meeting priority of the conflicting meeting. For example, the calendar scheduling server 102 may determine that the conflicting meeting can be rescheduled if the conflicting meeting has a relative low meeting priority. Alternatively, in some embodiments, the calendar scheduling server 102 may be configured to compare the meeting priority of the conflicting meeting to the meeting priority of the requested meeting to determine whether the conflicting meeting can be rescheduled or overbooked. In such embodiments, the calendar scheduling server 102 may determine that the conflicting meeting can be rescheduled or overbook if the conflicting meeting has a lower meeting priority relative to the meeting priority of the requested meeting.

Additionally or alternatively, in block 726, the calendar scheduling server 102 may determine whether a conflicting meeting can be rescheduled or overbooked based on a subject matter of the conflicting meeting (e.g., a conflicting meeting deemed to be of less importance, such as a status update meeting, may be determined to be available for rescheduling or overbooking). Additionally, in some embodiments in block 728, the calendar scheduling server 102 may determine whether a conflicting meeting can be rescheduled or overbooked based on the participant size of the conflicting meeting (e.g., a conflicting one-on-one meeting may be deemed to be available or otherwise easier to reschedule or overbook). Further, in some embodiments in block 730, the calendar scheduling server 102 may determine whether a conflicting meeting can be rescheduled or overbooked based on the location of the conflicting meeting (e.g., a local meeting may be deemed be available or otherwise easier to reschedule or overbook).

Additionally or alternatively, the calendar scheduling server 102 may attempt to reschedule or overbook a conflicting meeting based on characteristics of the participant having the conflicting meeting in block 732. In doing so, the calendar scheduling server 102 may consider any type of suitable characteristic of that participant. For example, in block 734, the calendar scheduling server 102 may determine whether a conflicting meeting can be rescheduled or overbooked based on the user hierarchy of the participant having the conflicting meeting. In doing so, the calendar scheduling server 102 may, for example, determine that the conflicting meeting can be rescheduled or overbooked if the user hierarchy of the participant having the conflicting meeting is less than the average user hierarchy of the rest of the participants or is less than the highest hierarchy of the rest of the participants.

Additionally, in some embodiments in block 736, the calendar scheduling server 102 may determine whether a conflicting meeting can be rescheduled or overbooked based on a user preference of the participant having the conflicting meeting. That is, the participant may define which types of meetings may be rescheduled or overbooked (e.g., the participant may have a preference that meetings having certain characteristics may or may not be rescheduled or overbooked). Additionally or alternatively, in block 738, the calendar scheduling server 102 may determine whether a conflicting meeting can be rescheduled or overbooked based on the user history of the participant having the conflicting meeting. For example, if the user has a tendency to accept the rescheduling or overbooking of certain types of conflicting meetings or does not attend certain types of conflicting meetings, the calendar scheduling server 102 may determine those types of conflicting meetings may be rescheduled or overbooked.

After the calendar scheduling server 102 has determined whether each identified conflicting meeting of the one or more participants is available for rescheduling or overbooking in block 716, the method 700 advances to block 740 of FIG. 7C. In block 740, the calendar scheduling server 102 attempts to adjust each conflicting meeting. For example, in block 742, the calendar scheduling server 102 may attempt to auto-reschedule the conflicting meeting by determining a new time slot for that conflicting meeting on the participant's digital calendar (and any other participants of that conflicting meeting). The calendar scheduling server 102 may use the methodologies disclosed herein to determine the new time slot for the rescheduled conflicting meeting. Alternatively, in block 744, the calendar scheduling server 102 may overbook the conflicting meeting by “ignoring” the conflicting meeting and scheduling the requested meeting over at least a portion of that conflicting meeting.

It should be appreciated that, in some embodiments, the rescheduling and overbooking of the conflicting meeting(s) is performed by the calendar scheduling server 102 in an autonomous manner. Alternatively, in some embodiments in block 746, the calendar scheduling server 102 may send an email to each participant having a rescheduled/overbooked conflicting meeting to confirm the acceptability of the proposed rescheduling/overbooking. Regardless, in block 748, the calendar scheduling server 102 determines whether the conflicting meeting(s) were successfully adjusted (e.g., accepted by the affected participant). If not, in block 750, the calendar scheduling server 102 sends an email to the host of the requested meeting that the requested new meeting could not be scheduled based on the determined meeting parameters and participants. In response, the host may manually update the meeting parameters and/or participants and request the calendar scheduling server 102 to attempt to schedule the meeting again or manually schedule the meeting themselves.

However, if the calendar scheduling server 102 is successful in rescheduling or overbooking the conflicting meeting(s), the method 700 loops back to bock 706 of FIG. 7A. As discussed above, in block 706, the calendar scheduling server 102 selects a time slot in which to schedule the meeting from the available time slots, which may now be available due to the rescheduling/overbooking of one or more conflicting meetings.

Referring now back to FIG. 4, after the calendar scheduling server 102 has identified the meeting time slot in which to schedule the requested meeting in block 426, the method 400 advances to block 428. In block 428, the calendar scheduling server 102 sends a meeting invite to each meeting participant for the identified meeting time slot. In block 430, the calendar scheduling server 102 determines whether each invite has been accepted. If not, the method 400 advances to block 432 in which the calendar scheduling server 102 determines whether any participant has rejected an invite. If so, the method 400 advances to block 434 in which the calendar scheduling server 102 attempts to reschedule the requested meeting to a different time slot using the methodologies discussed above. In doing so, the host participant may be notified and may update or modify certain meeting parameters (e.g., the acceptable time range, duration, time of day, etc.). In some embodiments, the calendar scheduling server 102 may provide suggestions or otherwise identify time slots that best satisfy the meeting parameters, includes the greatest number of available participants, requires the least number of rescheduling/overbooking, etc.

If, however, the calendar scheduling server 102 determines that all participants have been accepted in block 430, the method 400 advances to block 436. In block 436, the calendar scheduling server 102 sends an email to the host and each invitee to notify them that the requested meeting has been successfully scheduled and provides details of that scheduled meeting. The calendar scheduling server 102 may then monitor for any rescheduling requests received from any participant of the meeting in block 438. If the calendar scheduling server 102 receives a request to reschedule the scheduled meeting, the method 700 advances to block 434 in which the calendar scheduling server 102 attempts to reschedule the requested meeting to a different time slot using the methodologies discussed above. In this way, the calendar scheduling server 102 is configured to provide automated scheduling of meetings to participants upon request.

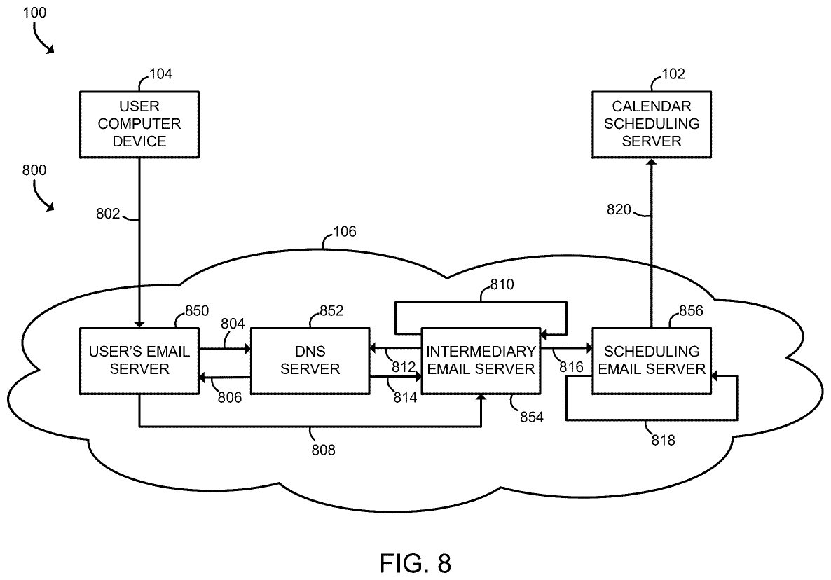

Referring now to FIG. 8, a process flow 800 illustrates an embodiment of the flow of an email communication from one of the user computer devices 104 (e.g., a “host” user computer device 104) to the calendar scheduling server 102 through various intermediary servers located in the network 106. The process flow begins with process 802 in which the user computer device 104 sends an email with the calendar scheduling server 102 identified as one of the recipients (e.g., as a carbon copy or blind carbon copy recipient). In the illustrative embodiment, the email communication is received by the user's Simple Mail Transfer Protocol (SMTP) email server 850, which is located in the network 106. In response, in process 804, the user's email server 850 queries a Domain Name Server (DNS) 852 for a Mail Exchange (MX) record that provides a connection path to the calendar scheduling server 102. The DNS 852 responds in process 806 with the requested MX record for the calendar scheduling server 102. The user's email server 850 analyzes the received MX record to determine the connection path and connects to an intermediary email server 854 in process 808 to forward along the email communication with a forwarding rule appended to the email communication, which directs the email communication to the calendar scheduling server 102. In process 810, the intermediary email server 854 analyzes the forwarding rule to determine the next connection in the email forwarding path and, in process 812, the intermediary email server 854 queries the DNS 852 for the MX record that provides a connection path to the SMTP email server 856 of the calendar scheduling server 102. The DNS 852 responds in process 814 with the requested MX record for the calendar scheduling server 102. The intermediary email server 854 analyzes the received MX record to determine the connection path and connects to the scheduling SMTP email server 856 in process 816 to forward along the email communication. In process 818, the scheduling SMTP email server 856 receives and processes the email communication to determine the recipient, which is the calendar scheduling server 102. As such, in process 820, the scheduling SMTP email server 856 forwards the email communication to the scheduling server 102 for processing using the methodologies described above. It should be appreciated that while a single intermediary email server 854 is shown in FIG. 8, the process flow may flow through additional intermediary email servers in other embodiments.

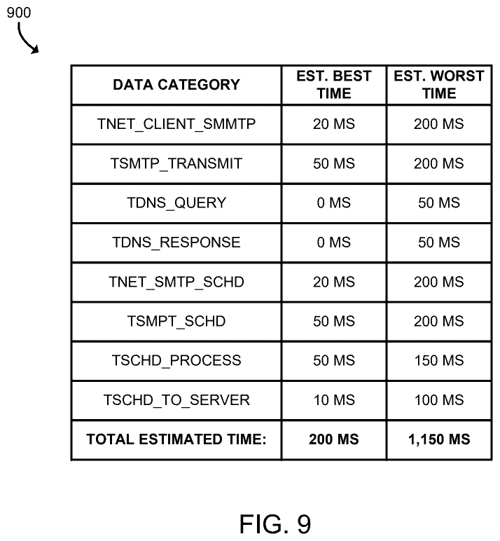

It should be appreciated that the system 100 effects the scheduling of a 1:1 or 1:Many meeting with increased speed and efficiency relative to typical ad hoc scheduling processes. For example, in the illustrative embodiment, the email propagation from the user computer device 104 to the calendar scheduling server 102 illustrated in FIG. 8 is estimated to complete within 200 to 1,150 milliseconds, which can facilitate the scheduling of a meeting in “real time” or “near real time.” For example, as table 900 of estimated best and worst times for completion of processes of the process flow 800 is shown in FIG. 9. As provided, the time required for the user computer device 104 to connect to the user's email server 850 (“Tnet_client_smtp”) is estimated to take from 20 milliseconds to 200 milliseconds. Additionally, the time required for the user computer 104 to handshake with the user's email server 850 and transmit the email communication (“Tsmtp_transmit”) is estimated to take from 50 milliseconds to 200 milliseconds.

The time required for the user's email server 850 to query the DNS server 852 for the MX records of the domain of the calendar scheduling server 102 (“Tdns_query”) is estimated to take from less than one milliseconds to 50 milliseconds, and the time required for the DNS server 852 to respond with the requested MX records (“Tdns_response”) is estimated to take from less than one milliseconds to 50 milliseconds.

Furthermore, the time required for the intermediary email server 854 to connect with the email communication to the scheduling email server 856 (“Tnet_smtp_schd”) is estimated to take from is estimated to take from 20 milliseconds to 200 milliseconds. The time required for the intermediary email server 854 to handshake with the scheduling email server 856 and transmit the email communication (“Tsmtp_schd”) is estimated to take from 50 milliseconds to 200 milliseconds. Additionally, the time required from the scheduling email server 856 to receive and process (e.g., filter) the email communication received from the intermediary email server 854 is estimated to take from 50 milliseconds to 150 milliseconds. And, the time required for the scheduling email server 856 to forward the email communication (or its metadata) to the calendar scheduling server 102 is estimated take 10 milliseconds to 100 milliseconds. In this way, the user computer device 104 is configured to communicate the email communication to the calendar scheduling server 102 in the estimated time frame of 200 milliseconds to 1,150 milliseconds, which supports the scheduling of meetings in “real time” or “near real time.”

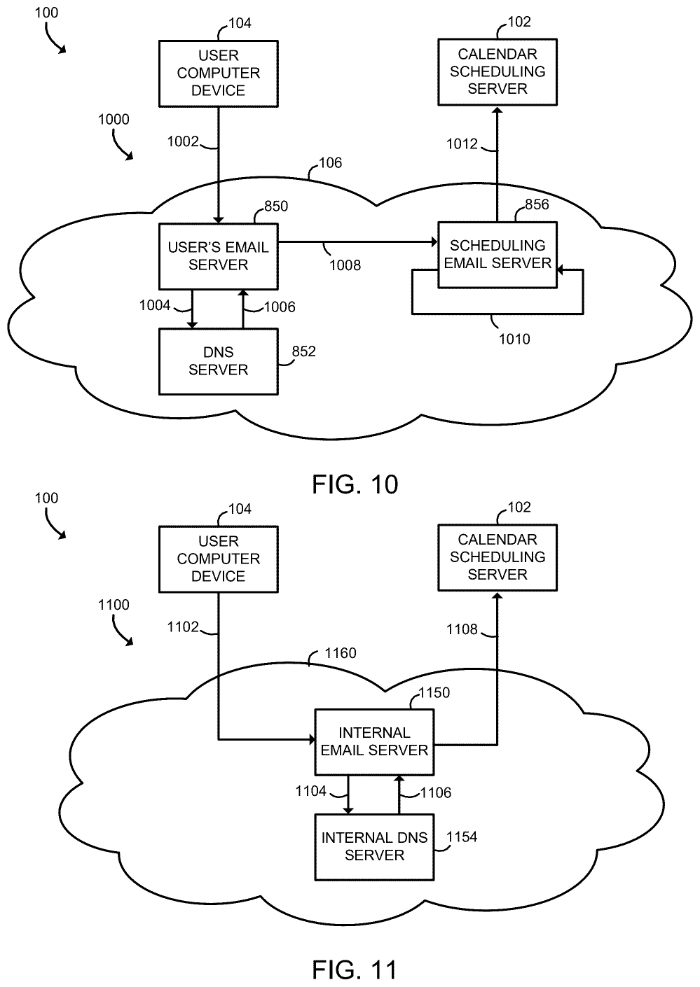

It should be appreciated that, in some embodiments, the calendar scheduling server 102 may be embodied as a dedicated server to, for example, a single enterprise. In such embodiments, the process flow may flow directly from the user's email server 850 to the scheduling email server 856 without the requirement of any intermediary email servers 854. For example, as shown in FIG. 10, a process flow 1000 illustrates an embodiment of the flow of an cmail communication from one of the user computer devices 104 (e.g., a “host” user computer device 104) to the calendar scheduling server 102 through a dedicated scheduling email server 856 located in the network 106. The process flow begins with process 1002 in which the user computer device 104 sends an email with the calendar scheduling server 102 identified as one of the recipients (e.g., as a carbon copy or blind carbon copy recipient). In the illustrative embodiment, the email communication is received by the user's SMTP email server 850. In response, in process 1004, the user's email server 850 queries the DNS 852 (e.g., a dedicated DNS) for an MX record that provides a connection path to the calendar scheduling server 102. The DNS 852 responds in process 1006 with the requested MX record for the calendar scheduling server 102. The user's email server 850 analyzes the received MX record to determine the connection path and connects to the scheduling SMTP email server 856 in process 1008 to forward along the email communication. In process 1010, the scheduling SMTP email server 856 receives and processes the email communication to determine the recipient, which is the calendar scheduling server 102. As such, in process 1012, the scheduling SMTP email server 856 forwards the email communication to the scheduling server 102 for processing using the methodologies described above.

In yet other embodiments, the calendar scheduling server 102 may be embodied as a local scheduling server dedicated to a single enterprise. In such embodiments, as shown in FIG. 11, an internal email server 1150 and internal DNS server 1154 are located in an internal network 1160, which may or may not have access to outside networks such as the Internet. In this way, the calendar scheduling server 102 may be embodied as a single enterprise scheduling solution configured to internal meeting scheduling. In such embodiments, a process flow 1100 begins with process 1102 in which the user computer device 104 sends an email with the calendar scheduling server 102 identified as one of the recipients (e.g., as a carbon copy or blind carbon copy recipient). In the illustrative embodiment, the email communication is received by the internal email server 1150. In response, in process 1104, the internal email server 1150 queries an internal DNS server 1154 for an MX record that provides a connection path to the calendar scheduling server 102. The DNS server 1154 responds in process 1106 with the requested MX record for the calendar scheduling server 102. The internal email server 1150 processes the email communication to determine the recipient, which is the calendar scheduling server 102. As such, in process 1108, the internal email server 1150 forwards the email communication to the scheduling server 102 for processing using the methodologies described above.

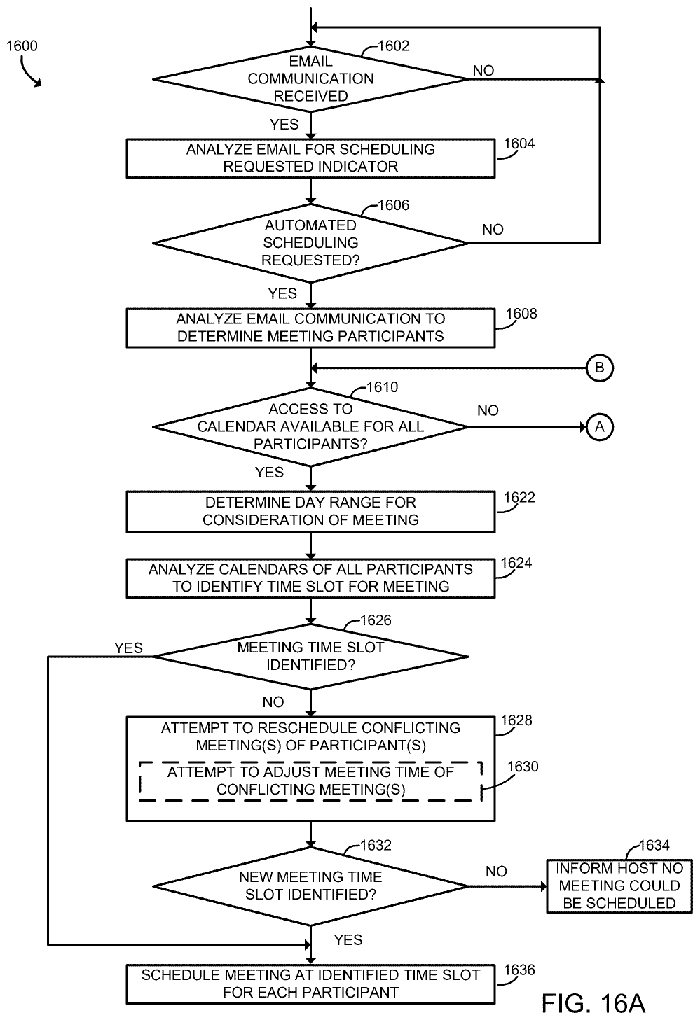

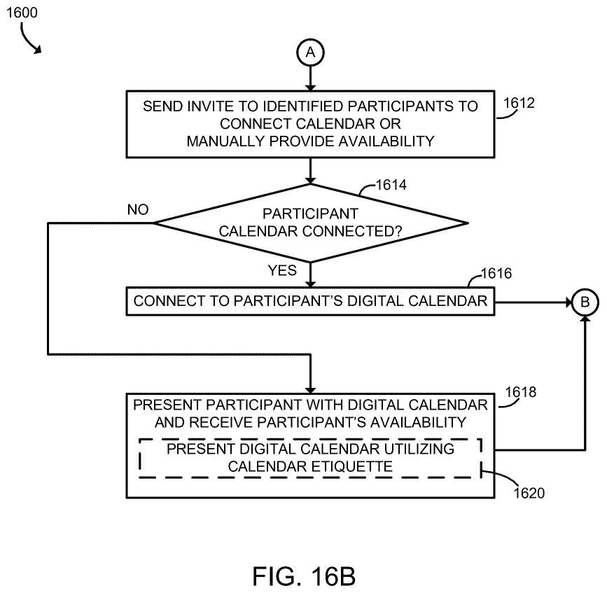

Referring now to FIGS. 16A and 16B, in another illustrative embodiment the calendar scheduling server 102 may execute a method 1600 for automated scheduling of a meeting. It should be appreciated that, in some embodiments, the operations of the method 1600 may be performed by one or more components of the environment 200 of the calendar scheduling server 102 as shown in FIG. 2. As described below, in the illustrative method 1600, the calendar scheduling server 102 is configured to analyze the availability of each participant of a proposed meeting and automatically schedule the meeting on their digital calendar. That is, in the illustrative embodiment method 1600, acceptance of the meeting by the invitee participant(s) is not required nor waited on. As such, a meeting can be scheduled between even a large group of participants with a relatively short period of time (e.g., within a few seconds from receiving the meeting request email).

The method 1600 begins with block 1602, in which the calendar scheduling server 102 determines whether an email communication has been received from one of the user computer devices 104 of the system 100. If so, the method 1600 advances to block 1604 in which the calendar scheduling server 102 analyzes the received email communication to determine whether the email communication includes a scheduling requested indicator that indicates a desire by the sender of the email communication to schedule a meeting. For example, as discussed above with regard to method 400, the scheduling requested indicator may be embodied as a carbon copy of an email address monitored by the calendar scheduling server 102. In such embodiments, a user of one of the user computer devices 104 may request the automated scheduling of a meeting by carbon copying the email address monitored by the calendar scheduling server 102. In other embodiments, however, other types of indicators of a desire to schedule a meeting may be used. For example, the email communication may include a direct instruction in the body of the email or the subject line, or the calendar scheduling server 102 may infer the desire to schedule a meeting based on the context of the email itself (e.g., by using natural language processing to understand the context and desire to schedule the meeting from the language used in the email communication).

If, in block 1606, the calendar scheduling server 102 determines that a request to schedule a meeting was not included in the received email communication, the method 1600 loops back to block 1602 in which the calendar scheduling server 102 continues to monitor for additional email communications. However, if the calendar scheduling server 102 determines, in block 1606, that automated scheduling of a meeting was requested, the method 1600 advances to block 1608. In block 1608, the calendar scheduling server 102 analyzes the email communication to determine the set of participants for the requested meeting. To do so, the calendar scheduling server 102 may utilize any suitable methodology and associated data. For example, in some embodiments, the calendar scheduling server 102 may determine the meeting participants based on the recipients of the email including the scheduling requested indicator. Additionally or alternatively, the calendar scheduling server 102 may execute the method 600 discussed above in regard to FIG. 6 to determine the participants of the requested meeting.

Regardless, after the calendar scheduling server 102 has determined the meeting participants in block 1608, the method 1600 advances to block 1610. In block 1610, the calendar scheduling server 102 determines whether access to the digital calendar of each meeting participant is available. As discussed above, each participant may be a registered user of the scheduling service offered by the calendar scheduling server 102 and, if so, the calendar scheduling server 102 may maintain the digital calendar for the registered participant. Alternatively, the digital calendar may be maintained individually by each participant on their respective user computer device 104 or via a third-party application.

If the calendar scheduling server 102 determines that access to one or more participant's digital calendar is not available, the method 1600 advances to block 1612 of FIG. 16B in which the calendar scheduling server 102 transmits an invite to the identified participant(s) to either connect or “link” their individual digital calendar to the calendar scheduling server 102 or to manually provide their availability on a digital calendar maintained by the calendar scheduling server 102 (see, e.g., FIG. 12 and associated discussion above). If the user determines to connect their own digital calendar in block 1614 (e.g., by selection of the selection link 1206 of), the method 400 advances to block 1618 in which the calendar scheduling server 102 connects to the participant's digital calendar. In doing so, the calendar scheduling server 102 may present a user interface 1300 to the participant on the participant's user computer device 104 as shown. As shown in FIG. 13, the illustrative user interface 1300 includes an indicia 1302 of the linked or connected, personal digital calendars of that participant. Additionally, the participant can add additional personally-maintained digital calendar via selection of a link 1304. Once the participant's digital calendar is linked in this manner, the calendar scheduling server 102 can analyze that participant's calendar or calendars as discussed below.

Referring again back to FIG. 16B, if the participant decides not to connect or link their digital calendar to the calendar scheduling server 102 in block 1614 (e.g., via selection of selection link 1208 of the user interface 1200 of FIG. 12), the method 1600 advances to block 1618. In block 1618, the calendar scheduling server 102 presents that participant with a digital calendar that is maintained by the calendar scheduling server 102. The participant may then provide their availability directly on the calendar maintained by the calendar scheduling server 102. For example, as shown in FIG. 14 and discussed in detail above, the calendar scheduling server 102 may present a user interface 1400 to the participant on the participant's user computer device 104, which includes the digital calendar 1402. Again, as discussed above, the digital calendar 1402 is maintained by the calendar scheduling server 102 and includes a set of time slots 1404, which the user may select to identify their availability. Each time slot 1404 may be color coded or emphasized using another visual mechanism capable of indicating the participant's availability. For example, the participant may select individual time slots 1404 to identify that they are “available,” “not available,” or “available-if-required.” In response, the calendar scheduling server 102 may update the background color of each time slot 1404. For example, “available” time blocks may be displayed with a green background, “not available” time blocks may be displayed with a red background, and “available-if-needed” may be displayed with a yellow background. It should be appreciated, however, that other coloring schemes may be used in other embodiments. Additionally, as discussed in detail above, the calendar scheduling server 102 may utilize a set of “calendar etiquette” in block 1620 when initially generating and displaying the digital calendar 1402 (e.g., by pre-defining time slots as “available,” “not available,” or “available-if-needed” depending on their particular time coverage, the particular day, user preferences, user hierarchy, user history, meeting priority, etc.)

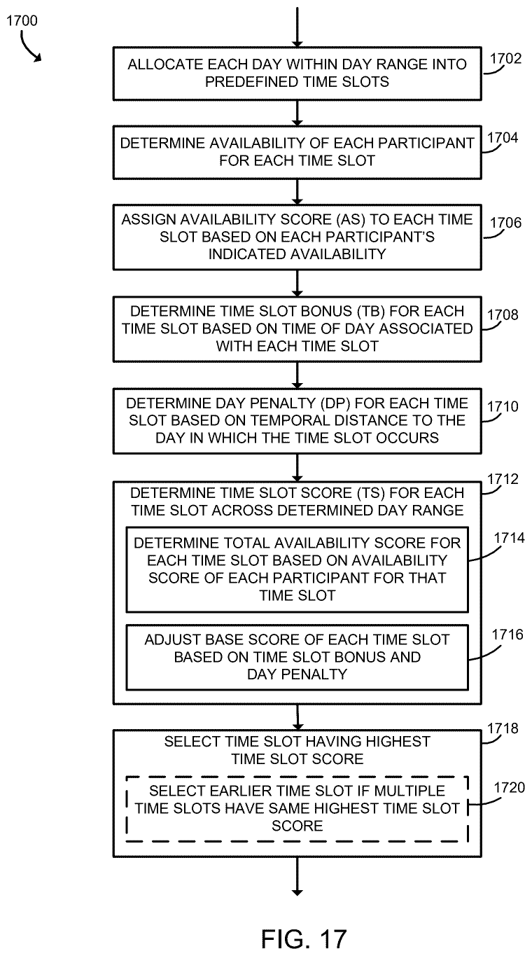

Regardless whether the participant opts to connect their digital calendar or provides their availability on the digital calendar maintained by the calendar scheduling server 102, the calendar scheduling server 102 may provide a notification to the participant that their availability response (either manually provided or inferred from their digital calendar) has been received (see, e.g., FIG. 15 and associated discussion above). The method 1600 subsequently loops back to block 1610 of FIG. 16A. In block 1610, the calendar scheduling server 102 confirms whether access to a digital calendar for each participant has been established (i.e., either the participant's own digital calendar or a digital calendar maintained by the calendar scheduling server 102). If so, the method 1600 advances to block 1622 in which the calendar scheduling server 102 determines a day range for the consideration of the requested meeting. To do so, the calendar scheduling server 102 may analyze the context of the received email to determine the day range (e.g., a day range or further date may be provided in the email) or the day range may be predefined (e.g., two weeks from receipt date of email). In some cases, the email may provide a specific date requested for the meeting. Subsequently, in block 1622, the calendar scheduling server 102 analyzes the digital calendars of each meeting participant to identify or determine a meeting time slot (i.e., a meeting day, time, and duration) for the meeting based on each participant's availability and characteristics of the considered meeting time slot. To do so, the calendar scheduling server 102 may execute a method 1700 for selecting an available meeting time slot for each meeting participant as shown in FIG. 17.

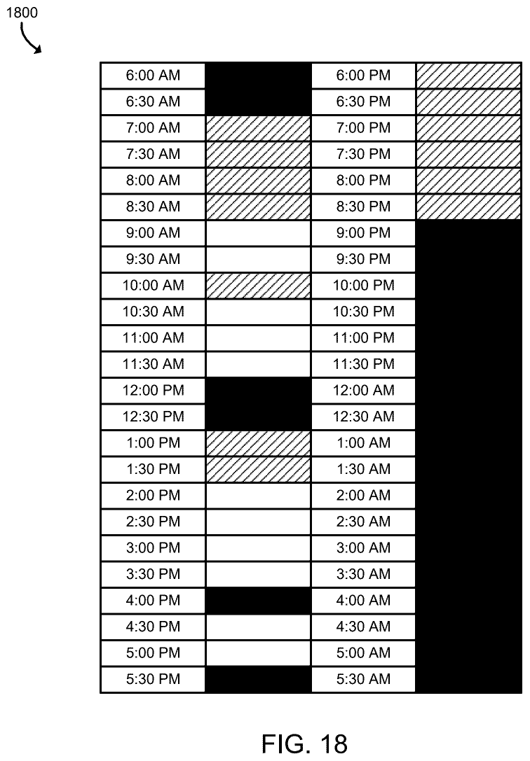

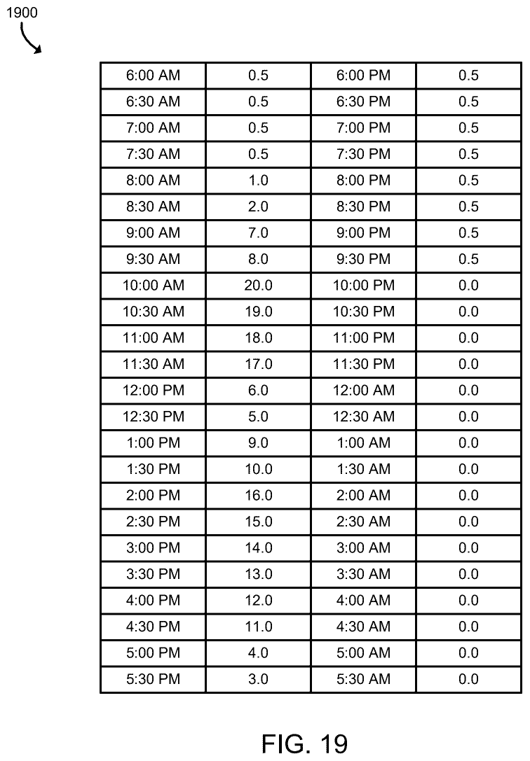

The method 1700 begins with block 1702 in which the calendar scheduling server 102 allocates each day within the day range determined in block 1622 of method 1600 into predefined time slots. In the illustrative embodiment, each time slot of each day has an identical temporal length. For example, in the illustrative embodiment, each time slot is defined as a 30 minute time slot beginning at the start of each hour and each half hour. An illustrative digital calendar 1800 of a single day is shown in FIG. 18, which has been divided into 48 half-hour time slots. As shown, each time slot has an associated indicia that provides an indication as to the participant's availability for that respective time slot. In the illustrative embodiment, a solid time slot indicates the participant is “not available” (e.g., has another meeting scheduled or is otherwise not available to take meetings), a hashed time slot indicates the participant is “available-if-required” (e.g., the participant desires to accept only important meetings), and an empty or clear time slot indicates the participant is “available.” As such, in the illustrative embodiment, the availability of each participant has been allocated to one of three different availability classifications. However, in other embodiments, additional or fewer availability classifications may be used to increase or decrease the observed granularity of the participant's availability. Additionally, in some embodiments, the availability of each time slot may be identified as colors (e.g., red for “not available,” yellow for “available-if-required,” and green for “available”) or other indicators.

Referring back to FIG. 17, after the calendar scheduling server 102 has allocated each day into the individual time slots in block 1702, the method 1700 advances to block 1704. In block 1704, the calendar scheduling server 102 determines an availability of each participant for each time slot of each day within the day range determined in block 1702. To do so, the calendar scheduling server 102 may analyze the digital calendar of each participant to determine or otherwise obtain the availability indicia associated with each time slot. For example, referring back to FIG. 18, the calendar scheduling server 102 may analyze the digital calendar 1800 to determine that the corresponding participant is “available-if-required” for time slots 7:00 AM, 7:30 AM, 8:00 AM, and 8:30 AM and “available” for time slots 9:00 AM and 9:30 AM, and so forth.

Referring again back to FIG. 17, after the calendar scheduling server 102 has determined the availability of each participant for each time slot of each day within the day range in block 1704, the method 1700 advances to block 1706. In block 1706, the calendar scheduling server 102 assigns an availability score (AS) to each time slot based on the determined availability of each participant for that time slot. That is, in the illustrative embodiment, each availability classification (e.g., “available,” available-if-required,” and “not available”) has a corresponding availability score associated with it. For example, in the illustrative embodiment, the calendar scheduling server 102 assigns a higher availability score to the time slot for a respective participant if the participant is “available,” a lower availability score to the time slot for the respective participant if the participant is “available-if-required,” and a minimal availability score. In a particular illustrative embodiment, the calendar scheduling server 102 is configured to assign an availability score of 100 points for the time slot if the respective participant is “available,” 0 points for the time slot if the respective participant is “available-if-required” or “not available.” However, in other embodiments, other scoring schemas may be used (e.g., 100 points for “available,” 50 points for “available-if-required,” and 0 points for “not available”).

After the calendar scheduling server 102 has assigned the availability score to each time slot in block 1706, the method 1700 advances to block 1708 in which the calendar scheduling server 102 determines a time slot bonus (TB) for each time slot based on the time of day associated with each respective time slot. In this way, in the illustrative embodiment, the calendar scheduling server 102 provides a bonus for time slots occurring in the typical workplace hours, which may vary at times of typical unavailableness (e.g., around noon for lunchtime). For example, an illustrative time chart 1900 is shown in FIG. 9 and includes a time slot bonus for each defined time slot throughout the day based on the time of the day at which the respective time slot occurs. In the illustrative embodiment, the assigned time slot bonuses range from 0.0 to 20.0, but may have a different range in other embodiments. Additionally, in some embodiments, the time slot bonus may be modified throughout the year to account for differences in work life over different seasons, be a function of each particular participant, and/or be based on historical data.

Referring back to FIG. 17, after the calendar scheduling server 102 has determined the time slot bonus for each time slot in block 1708, the method 1700 advances to block 1710. In block 1710, the calendar scheduling server 102 determines a day penalty (DP) for each time slot based on a temporal distance from the present day to the day on which the respective time slot occurs. For example, in the illustrative embodiment, time slots occurring on days that are farther from the present day than other time slots occurring on days closer to the present day will have a relative increased penalty. That is, the day penalty progressively increases as a function of the temporal distance to the day on which the time slot occurs. The progressive increase may be linear or each day may have an increasing penalty relative to the day before it. The particular value of each day penalty may be determined based on the specific implementation, on historical data, or other criteria. Regardless, in the illustrative embodiment, each successive day has an associated penalty and the day penalty for that time slot is equal to the sum of the penalty for each intervening day. In some embodiments, however, the calendar scheduling server 102 is configured to ignore weekend days in the calculation of the day penalty.

After the calendar scheduling server 102 has determined the day penalty for each time slot in block 1710, the method 1700 advances to block 1712 in which the calendar scheduling server 102 determines a time slot score (TS) for each time slot across the day range. To do so, in block 1714, the calendar scheduling server 102 determines a total availability score for each time slot based on the individual availability scores of each participant for the respective time slot. In the illustrative embodiment, for example, the calendar scheduling server 102 determines total availability score by multiplying the number of participants having each availability classification (e.g., “available,” available-if-required,” and “not available”) by the availability score (i.e., a weighting factor) assigned to that availability classification (e.g., 100 points for “available,” 50 points for “available-if-required,” and 0 points for “not available”) and summing the resulting products. Subsequently, in block 1716, the calendar scheduling server 102 adjusts the base availability score based on the time slot bonus for each respective time slot as determined in block 1706 and the day penalty for each time slot as determined in block 1710 to determine the total slot score for that respective time slot. For example, in the illustrative embodiment, the calendar scheduling server 102 determines the time slot score for each time slot by adding the time slot bonus for the respect time slot to the base availability score for the respective time slot and subtracting the day penalty for the respective time slot. To do so, in some embodiments, the calendar scheduling server 102 may be configured to use the following equation: TS=ASₜ+TBₜ−DPₜ, wherein TSₜ is the time slot score for time slot “t”, ASₜ is the total availability score for time slot “t”, and DPₜ is the day penalty slot score for time slot “t”.

After the calendar scheduling server 102 has determined the time slot score for each time slot in the determined day range in block 1712, the method 1700 advances to block 1718. In block 1718, the calendar scheduling server 102 selects the time slot having the highest time slot score in which the schedule the requested meeting. If the calendar scheduling server 102 determines that multiple time slots each have the same highest times lot score, the calendar scheduling server 102 may select the time slot that is earliest in time (i.e., closes to the present day) in block 1720.

Referring now back to FIG. 16A, after the calendar scheduling server 102 analyzes the digital calendars of all participants to identify a time slot for the requested meeting in block 1624, the method 1600 advances to block 1626. In block 1626, the calendar scheduling server 102 determines whether a time slot was successfully identified in block 1624. For example, the calendar scheduling server 102 may be unable to identify a suitable time slot due to the unavailability of one or more participants in the identified day range. Additionally or alternatively, in some embodiments, the calendar scheduling server 102 may determine that no acceptable time slot is available if all time slots have an time slot score (TS) of less than a predetermined threshold.

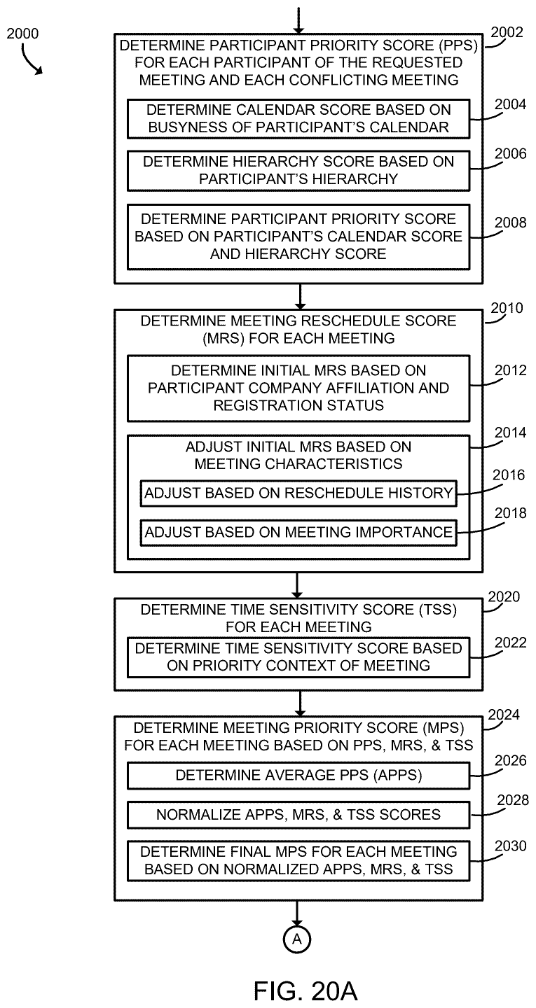

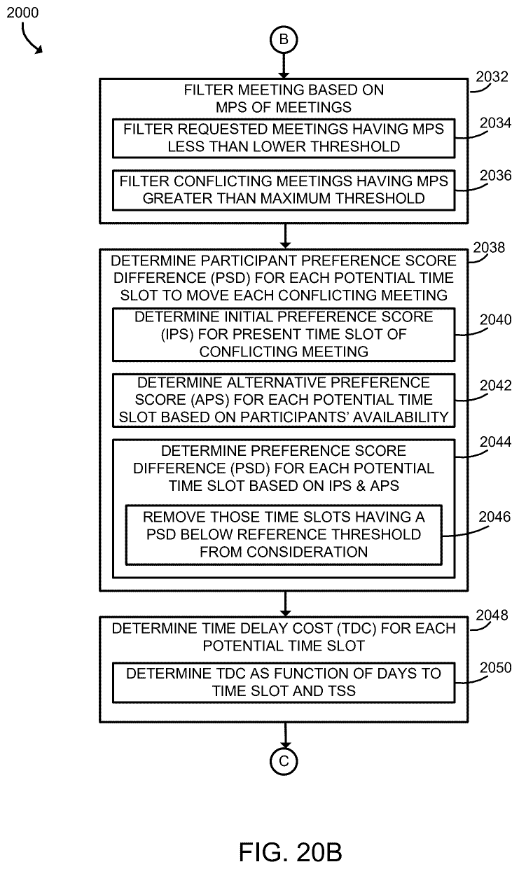

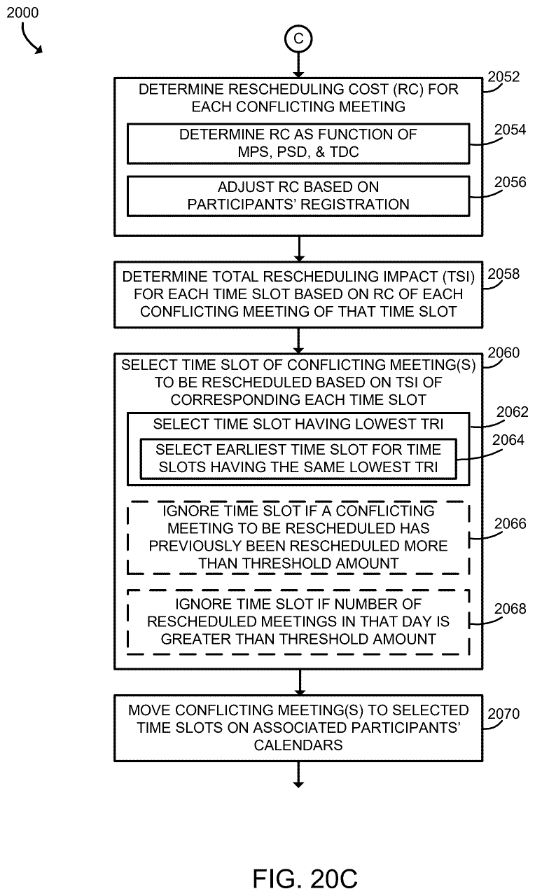

If the calendar scheduling server 102 was unable to identify an acceptable time slot for each participant within the identified date range, the method 1600 advances to block 1628. In block 1628, the calendar scheduling server 102 attempts to reschedule one or more conflicting meetings of one or more participants located in a time slot within the identified date range. To do so, the calendar scheduling server 102 may execute a method 2000 for automated rescheduling of conflicting meetings of participants as shown in FIGS. 20A-20C.

The method 2000 begins with block 2002 in which the calendar scheduling server 102 determines a participant priority score (PPS) for each participant of the requested meeting and each identified conflicting meeting, which may occur in the same time slot. That is, it should be that each time slot with the day range may include multiple conflicting meetings for one or more participants of the requested participants. The participant priority score (PPS) is indicative of an importance of each participant relative to other participants of the requested meeting. In the illustrative embodiment, the calendar scheduling server 102 determines participant priority score (PPS) by determining a calendar score for each participant based on a qualification of how busy that participant is over a reference day range (e.g., over the next seven days). To do so, for example, the calendar scheduling server 102 may determine the total number of time slots each participant has an availability classification of “available” over the reference day range. The calendar scheduling server 102 assigns the calendar score based on the amount or total number of available time slots. For example, the calendar scheduling server 102 may quantize the total number of available time slots by grouping the total number of available time slots into defined groups and assign each group a corresponding calendar score (e.g., a calendar score of “1” for a total number of available time slots greater than a first reference number, a calendar score of “2” for a total number of available time slots between the first reference number of a smaller second reference number, and a calendar score of “3” for a total number of available time slots less than the second reference number).

Additionally, in block 2006, the calendar scheduling server 102 determines a hierarchy score for each participant of the requested meeting. The hierarchy score is indicative of a seniority or ranking of the corresponding participant relative to other participants of the requested meeting. In some embodiments, the calendar scheduling server 102 may determine a hierarchy score for each participant based on pre-define hierarchies. For example, the hierarchy scores may be pre-defined for each user (e.g., assigned at time of employment) and/or maintained over subsequent iterations of the method 2000. Additionally or alternatively, in other embodiments, the calendar scheduling server 102 may determine the hierarchy score for one or more of the participants based on a job title associated with that respective participant. In doing so, for example, the calendar scheduling server 102 may assign a higher hierarchy score for executive-level employees relative to non-executive level employees, a higher hierarchy score to team leads relative to team members, and so forth. In some embodiments, the calendar scheduling server 102 may be configured to determine the job title of one or more participants using publicly available databases, data repositories, and/or other data sources. For example, the calendar scheduling server 102 may be configured to search social media accounts (e.g., Linkedin®, Facebook®, etc.) of the participants to determine a job title and associated hierarchy for the participants. The number of defined levels of hierarchy and the associated hierarchy scores may be implementation dependent. For example, in one illustrative embodiment, the calendar scheduling server 102 may assign a hierarchy score of “1” for entry level positions (e.g., Intern/Assistant), a hierarchy score of “2” for junior level positions (e.g., Specialist/Analyst), a hierarchy score of “3” for mid-level positions (e.g., Manager/Lead), a hierarchy score of “4” for senior level positions (e.g., Director/VP), and a hierarchy score of “5” for executive level positions (e.g., C-level/Founder).

Subsequently, in block 2008, the calendar scheduling server 102 determines the participant priority score (PPS) for each participant based on the calendar score and the hierarchy score for that particular participant. To do so, in the illustrative embodiment, the calendar scheduling server 102 is configured to weight the calendar score by a first weighting factor and weight the hierarchy score by a second weighting factor and sum the weighted calendar score and weighted hierarchy score to determine the corresponding participant priority score (PPS). For example, the calendar scheduling server 102 may determine the participant priority score (PPS) for each participant using the following equation: PPSₚ=(CSₚ×WF1)+ (HSₚ× WF2), wherein PPSₚ is the participant priority score for participant “p”, CSₚ is the calendar score for participant “p”, WF1 is a weighting factor for the calendar scores, HSₚ is the hierarchy score for participant “p”, and WF2 is a weighting factor for the hierarchy scores. In the illustrative embodiment, the first weighting factor, WF1, is equal to 0.3 and the second weighting factor, WF2, is equal to 0.7; however, other weighting factors may be used in other embodiments.

After the calendar scheduling server 102 has determined the participant priority score (PPS) in block 2002, the method 2000 advances to block 2010. In block 2010, the calendar scheduling server 102 is configured to determine a meeting reschedule score (MRS) for requested meeting and each conflicting meeting. The meeting reschedule score (MRS) is an indication of a level of difficulty of rescheduling the corresponding meeting. To determine the meeting reschedule score (MRS) for each meeting, the calendar scheduling server 102 determines an initial meeting reschedule score based on each participant's company affiliation and registration status in block 2012. The company affiliation is an indication of whether the corresponding participant is an employee of the same company as the organizer of the meeting (i.e., the sender of the email request). The registration status is an indication of whether the corresponding participant utilizes a digital calendar maintained by the calendar scheduling server 102 (compared to a digital calendar simply accessible by the calendar scheduling server 102). As such, in the illustrative embodiments, four different initial meeting reschedule score (MRS) classifications are defined: external, non-registered user; external, registered user; internal, non-registered user; and internal, registered user. The calendar scheduling server 102 may apply a different initial meeting reschedule score to each of the four different classifications. For example, in the illustrative embodiment, the calendar scheduling server 102 assigns an initial MRS of 2.0 for “external, non-registered” users, an initial MRS of 1.0 for “external, registered” users, an initial MRS of 1.5 for “internal, non-registered” users, and an initial MRS of 5.0 for “internal, non-registered” users.

Subsequently, in block 2014, the calendar scheduling server 102 adjusts the initial meeting reschedule score (MRS) based on characteristics of the respective meeting (i.e., of the requested meeting and of each conflicting meeting). For example, in block 2016, the calendar scheduling server 102 may apply an adjustment if the corresponding meeting has been previously rescheduled (e.g., a “+2” if the meeting has been previously rescheduled). In some embodiments, the adjustment performed in block 2016 may increase with the number of prior rescheduling. In block 2018, the calendar scheduling server 102 may apply an adjustment based on a determined level of importance of the corresponding meeting. The level of importance of the meeting may be predefined or inferred by the calendar scheduling server 102 based on various meeting characteristics such as, for example, the participants of the meeting, the title of the meeting, the location of the meeting, and so forth.

After the calendar scheduling server 102 has determined the meeting reschedule score for each meeting in block 2010, the method 2000 advances to block 2020 in which the calendar scheduling server 102 determines a time sensitivity score (TSS) for each meeting (i.e., for the requested meeting and for each conflicting meeting). The time sensitivity score (TSS) is indicative of an urgency of the corresponding meeting. To determine the time sensitivity score (TSS), the calendar scheduling server 102 may determine a priority context of each meeting in block 2022 and apply a score based on the determined priority context. For example, in the illustrative embodiment, the calendar scheduling server 102 assigns a TSS of 5.0 if the meeting is a “critical” meeting, a TSS of 4.0 if the meeting is a “high priority” meeting, a TSS of 3.0 if the meeting is a “normal priority” meeting, a TSS of 2.0 if the meeting is a “low priority” meeting, and a TSS of 1.0 if the meeting is a “very low priority” meeting. To determine the priority context of the meeting, the calendar scheduling server 102 may analyze any suitable characteristic of the meeting including an indicated priority, the title of the meeting, the context of the meeting, key words included in the meeting or email (e.g., “Urgent”), the location of the meeting, and/or other aspects of the meeting.

Subsequently, in block 2024, the calendar scheduling server 102 determines a meeting priority score (MPS) for each meeting based on the participant priority score (PPS) determined in block 2002, the meeting reschedule score (MRS) determined in block 2010, and the time sensitivity score (TSS) determined in block 2020. The meeting priority score (MPS) is indicative of a relative priority of the corresponding meeting. In the illustrative embodiment, to determine the meeting priority score (MPS), the calendar scheduling server 102 initially determines an average participant priority score (APPS) as a function of the participant priority score (PPS) for each participant of the corresponding meeting and the total number of participants of the corresponding meeting. That is, for each meeting, the calendar scheduling server 102 sums the participant priority scores (PPS) of the respective meeting and divides that sum by the number of participants for that respective meeting.

In block 2028, the calendar scheduling server 102 normalizes each of the average participant priority score (APPS), the meeting reschedule score (MRS), and the time sensitivity score (TSS). For example, in the illustrative embodiment, the calendar scheduling server 102 normalizes each of the APPS, MRS, and TSS scores to a scale of 0.0 to 1.0. To do so, in an illustrative embodiment, the calendar scheduling server 102 may determine the minimum and maximum score of each of the APPS, MRS, and TSS; subtract the minimum score from each respective APPS, MRS, TSS score; and divide the resulting difference by the maximum score to normalize each score across a scale from 0.0 to 1.0.

Subsequently, in block 2030, the calendar scheduling server 102 determines the final meeting priority score (MRS) based on the normalized APPS, MRS, and TSS determined in block 2028. To do so, in the illustrative embodiment, the calendar scheduling server 102 is configured to apply a weighting factor to each of the normalized scores. For example, in the illustrative embodiments, the calendar scheduling server 102 may determine the meeting priority score (MRS) using the following equation: MPSₘ=(nMRSₘ×WF1)+ (nAPPSₘ× WF2)+ (nTSSₘ×WF3), wherein MPSₘ is the meeting priority score for meeting “m”, nMRSₘ is the normalized meeting reschedule score for meeting “m”, WF1 is the first weighting factor, nAPPSₘ is the normalized average participant priority score for meeting “m”, WF2 is the second weighting factor, nTSSₘ is the normalized time sensitivity score for meeting “m”, and WF3 is the third weighting factor. The particular values of the weighting factors WF1, WF2, and WF3 may be implementation dependent so as to weigh each normalized score by an intended amount for that particular implementation. For example, in an illustrative embodiment, the first weighting factor, WF1, is equal to 0.4, the second weighting factor, WF2, is equal to 0.3, and the third weighting factor, WF3, is equal to 0.3.

After the calendar scheduling server 102 has determined the meeting priority score (MPS) for each meeting in block 2024, the method 2000 advances to block 2032 of FIG. 20B. In block 2032, the calendar scheduling server 102 performs a filtering process to filter out meetings from consideration based on the value of the meeting priority score (MPS) of the corresponding meeting. For example, in block 2034, the calendar scheduling server 102 filters out requested meetings having a meeting priority score (MPS) less than a reference lower threshold. That is, the calendar scheduling server 102 may not consider rescheduling conflicting meetings for requested meetings that have a low meeting priority score (MPS) (e.g., MPS<0.4). If the requested meeting has a medium meeting priority score (MPS) (e.g., 0.4≤MPS≥0.7), the calendar scheduling server 102 may attempt to reschedule the conflicting meetings that are not of high priority (e.g., conflicting meetings having an MPS below a reference threshold). Alternatively, if the requested meeting has a high meeting priority score (MPS) (e.g., MPS≥0.7), the calendar scheduling server 102 may attempt to reschedule any conflicting meeting having an MPS less than the MPS of the requested meeting. Additionally, in block 2036, the calendar scheduling server 102 may be configured to filter conflicting meetings from consideration based on the meeting priority score (MPS) of the corresponding conflicting meeting. For example, if the conflicting meeting has a meeting priority score (MPS) greater than a reference maximum threshold (e.g., MPS≥0.7), the calendar scheduling server 102 may not consider that conflicting meeting for rescheduling.

Regardless, after the calendar scheduling server 102 has filtered meetings based on their respective meeting priority scores (MPS) in block 2032, the method 2000 advances to block 2038. In block 2038, the calendar scheduling server 102 determines a participant preference score difference (PSD) for each potential time slot to which to move each conflicting meeting. The participant preference score (PSD) defines a preference of a corresponding participant for the conflicting meeting relative to the corresponding, identified time slot to which to move the conflicting meeting. The potential time slots may be identified by the calendar scheduling server 102 over a range of days from the current day of the conflicting meeting (e.g., within one week, within one month, etc.).

To determine the participant preference score difference (PSD), the calendar scheduling server 102 may determine an initial preference score (IPS) for the present time slot of the conflicting meeting in block 2040. To do so, in the illustrative embodiment, the calendar scheduling server 102 is configured to determine the initial preference score (IPS) based on the availability of each participant of the requested meeting for the time slot of the of the conflicting meeting. That is, similar to the total availability score determined in block 1714 of method 1700 discussed above, the calendar scheduling server 102 determines the sum of the number of each available classification (i.e., the number of participants that are “available,” available-if-required,” and “not available”) multiplied by a corresponding weighting factor, which may be different from the availability score assigned to each available classification described above. For example, in the illustrative embodiment, the “available” classification is multiplied by a weighting factor of 2.0, the “available-if-required” classification is multiplied by a weighting factor of 1.0, and the “unavailable” classification is multiplied by a weighting factor of −100.0. It should be appreciated that, while some participants will be “unavailable” as they are a participant in the conflicting meeting, other participants of the requested meeting may be available for the time slot of the conflicting meeting.

In block 2042, the calendar scheduling server 102 determines an alternative preference score (APS) for each potential time slot to which the conflicting meeting may be moved based on the availability of each participant of the requested meeting for corresponding potential time slot. To do so, the calendar scheduling server 102 may determine the sum of the number of each available classification (i.e., the number of participants that are “available,” available-if-required,” and “not available”) multiplied by a corresponding weighting factor, which may be the same values as the weighting factors used to determine the initial preference score (IPS) in block 2040. Subsequently, in block 2044, the calendar scheduling server 102 determines the preference score difference (PDS) for each potential time slot based on the determined initial preference score (IPS) for the present time slot of the conflicting meeting and the determined alternative preference score (APS) for each potential time slot. For example, in an illustrative embodiment, the calendar scheduling server 102 determines the preference score difference (PDS) by subtracting the alternative preference score (APS) from the initial preference score (IPS) (e.g., PSD=IPS−APS). In such embodiments, in block 2046, the calendar scheduling server 102 removes those potential time slots from consideration that having PSD score below a reference threshold.

After the calendar scheduling server 102 has determined the preference score difference (PDS) for each potential time slot in block 2038 and filtered the potential time slots based thereon, the method 2000 advances to block 2048. In block 2048, the calendar scheduling server 102 determines a time delay cost (TDC) for each remaining potential time slot. The time delay cost (TDC) is indicative of a reduction of an urgency of the conflicting meeting as a function of temporal distance between the conflicting meeting and the corresponding time slot. That is, the time delay cost (TDC) is a measurement of the impact to the urgency of the conflicting meeting by moving the conflicting meeting to a later time slot (i.e., a later date). Specifically, in block 2050, the calendar scheduling server 102 is configured to determine the time delay cost (TDC) as a function of the days from the present day of the conflicting meeting to the day of the potential time slot and the time sensitivity score (TSS) of the conflicting meeting. To do so, in the illustrative embodiment, the calendar scheduling server 102 is configured to determine the time delay cost by multiplying the days from the present day of the conflicting meeting (DAYS) by the time sensitive score (TSS) (i.e., TDC=DAYS−TSS).

After the calendar scheduling server 102 has determined the time delay cost for each remaining potential time slot in block 2048, the method 2000 advances to block 2052 of FIG. 20C. In block 2052, the calendar scheduling server 102 determines a rescheduling cost (RC) for each conflicting meeting. To do so, in block 2054, the calendar scheduling server 102 is configured to determine the rescheduling cost (RC) of each conflicting meeting as a function of the meeting priority score (MPS) of the respective conflicting meeting, the participant preference score difference (PSD) for each participant of the respective conflicting meeting, and the time delay cost (TDC) of each remaining potential time slot to which to move the respective conflicting meeting. In the illustrative embodiment, the calendar scheduling server 102 is configured to multiply each of the MPS, the PSD, and the TDC by a corresponding weighting factor and determine the sum of the weighted MPS, PSD, and the TDC to determine the resulting rescheduling cost (RC) of that particular conflicting meeting. For example, the calendar scheduling server 102 may determine the rescheduling cost (RC) using the following equation: RC=(MPS× WF1)+ (PSD× WF2)+ (TDCₛ×WF3), wherein RCₛ is the rescheduling cost for the respective time slot “s,” MPS_{c} is the meeting priority score for respective conflicting meeting “c”, WF1 is a first weighting factor, PSD_{c} is the participant preference score difference for each participant of the respective conflicting meeting “c”, WF2 is a second weighting factor, TDCₛ is the time delay cost for the respective time slot “s”, and WF3 is a third weighting factor. The particular values for the weighting factors WF1, WF2, and WF3 may be dependent on the particular implementation. However, in the illustrative embodiment, WF1 is equal to the average the average participant priority score (APPS) as determined in block 2026, the weighting factor WF2 is equal to 5.0, and WF3 is equal to 2.0.

After the calendar scheduling server 102 has determined the rescheduling cost (RC) for each conflicting meeting in block 2056, the calendar scheduling server 102 adjusts each determined rescheduling cost (RC) based on participants' registration status. That is, the rescheduling cost (RC) is adjusted dependent on whether the calendar scheduling server 102 maintains the digital calendar of each participant. For example, in the illustrative embodiment, calendar scheduling server 102 reduces the rescheduling cost (RC) of a conflicting meeting reduced by 20% if all participants of the conflicting meeting are registered participants and increases the rescheduling cost (RC) of the conflicting meeting by 20% if any of the participants are not registered participants.

Subsequently, in block 2058, the calendar scheduling server 102 determines a total rescheduling impact (TSI) for each time slot associated with one or more conflicting meetings based on the rescheduling cost (RC) of each conflicting meeting located in that respective time slot. That is, it should be appreciated that any time slot may have multiple conflicting meetings for various sub-groups of participants of the requested meeting. As such, in the illustrative embodiment, the calendar scheduling server 102 is configured to sum the rescheduling cost (RC) of each conflicting meeting of a respective time slot to determine the total rescheduling impact (TSI) of that respective time slot.

In block 2060, the calendar scheduling server 102 selects the time slot having one or more conflicting meetings to be rescheduled based on the total rescheduling impact (TSI) of each conflicting time slot. To do so, in block 2062, the calendar scheduling server 102 selects the time slot having the lowest total rescheduling impact (TSI). If two or more time slots have the same total rescheduling impacts (TSIs), the calendar scheduling server 102 selects the earliest time slot in block 2064. Additionally, in some embodiments in block 2066, the calendar scheduling server 102 may ignore a time slot of one or more conflicting meetings if an associated conflicting meeting has been previously rescheduled more than a reference threshold amount (e.g., has been rescheduled twice previously). Additionally or alternatively, in some embodiments in block 2068, the calendar scheduling server 102 ignores a time slot of one or more conflicting meetings if a number of rescheduled meetings in the same day for an individual participant is greater than a reference threshold amount (e.g., greater than two rescheduled meetings in a single day).

Regardless, after the calendar scheduling server 102 determines the conflicting meeting(s) to be moved and the associated time slot to which to move those conflicting meetings, the method 2000 advances to block 2070 in which the calendar scheduling server 102 moves the one or more conflicting meetings from the present time slot to the new time slot. In this way, the calendar scheduling server 102 can automatically reschedule conflicting meetings to facilitate the scheduling of the newly requested meeting.

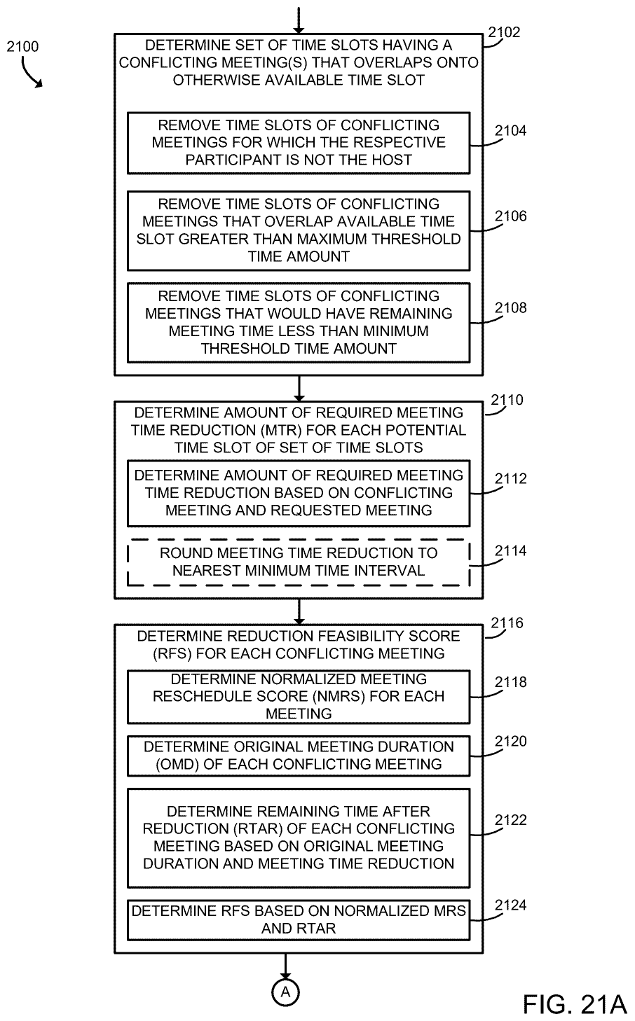

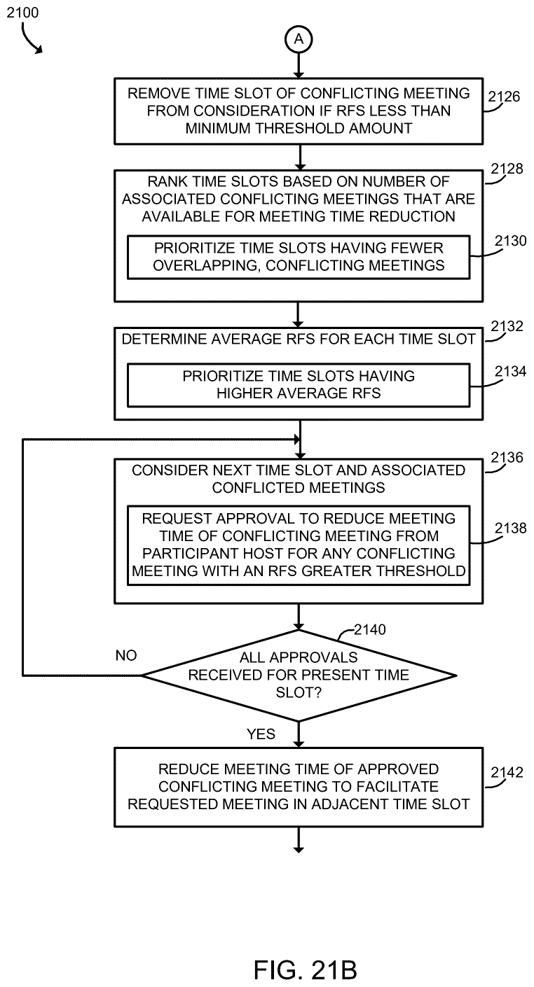

Referring back to FIG. 16A, in some embodiments and as part of attempting to reschedule conflicting meetings, the calendar scheduling server 102 may be configured to analyze the meeting time of one or more conflicting meetings and determine whether such meeting time can be adjusted in block 1630. To do so, as shown in FIG. 21, the calendar scheduling server 102 may execute a method 2100 for adjusting the meeting time of one or more conflicting meetings. The method 2100 beings with block 2102 in which the calendar scheduling server 102 determines a set of time slots of which has one or more conflicting meetings that overlap onto an otherwise available time slot (i.e., a time slot that would otherwise be available for the requested meeting). To do so, for example, the calendar scheduling server 102 may analyze the digital calendar of all participants to identify time slots having associated meetings that are adjacent to otherwise open time slots (e.g., time slots of other participants that do not have a present meeting in those time slots). As such, the resulting set of time slots defines those time slots that are potentially modifiable with regard to their meeting duration to facilitate the scheduling of the requested meeting in an adjacent time slot.

In doing so, in block 2104, the calendar scheduling server 102 may be configured to remove those time slots having conflicting meetings from consideration for which the respective participant is not the host. That is, if the conflicting meeting is hosted by someone other than a participant of the requested meeting, the time slot associated with that conflicting meeting is removed from the set of potential time slots. Additionally, in block 2106, the calendar scheduling server 102 may remove those time slots that overall the potentially available time slot greater than a threshold amount of time. For example, in the illustrative embodiment, the calendar scheduling server 102 is configured to remove from consideration those time slots having a conflicting meeting that overlaps the potentially available time slot by more than 15 minutes. Furthermore, in block 2108, the calendar scheduling server 102 may remove those time slots for which their remaining meeting time, after a reduction to facilitate the scheduling of the requested meeting, would be less than a reference minimum threshold time amount. For example, in the illustrative embodiment, the calendar scheduling server 102 is configured to remove from consideration those time slots having a conflicting meeting that would have a remaining meeting duration of less than 30 minutes after the required reduction in meeting duration facilitate the scheduling of the requested meeting.

Subsequently, in block 2110, the calendar scheduling server 102 determines the amount of required meeting time reduction (MTR) for each time slot of the set of time slots associated with the conflicting meetings. To do so, in block 2112, the calendar scheduling server 102 may determine the amount of required meeting time reduction (MTR) based on the present duration of the respective conflicting meeting and the duration of the requested meeting. For example, the calendar scheduling server 102 may be configured to determined how much time the conflicting meeting would need to be reduced to allow the requested meeting to be scheduled in an adjacent time slot. In some embodiments, in block 2114, the calendar scheduling server 102 may round the determined meeting time reduction to the nearest minimum time interval (e.g., to 15 minutes, 30 minutes, etc.), as established the calendar scheduling server 102 and/or a user, in some embodiments.

In block 2116, the calendar scheduling server 102 determines a reduction feasibility score (RFS) for each conflicting meeting. To do so, in block 2118, the calendar scheduling server 102 determines a normalized meeting reschedule score (nMRS). The calendar scheduling server 102 may determine the normalized meeting reschedule score (nMRS) using the process described above in regard to blocks 2010 and 2024 of method 2000. After the calendar scheduling server 102 has determined the normalized meeting reschedule score (nMRS) in block 2118, the calendar scheduling server 102 determines the original meeting duration (OMD) of each conflicting meeting in block 2120. The calendar scheduling server 102 may determine the duration of each conflicting meeting by analyzing the digital calendar of each respective participant.

Subsequently, in block 2122, the calendar scheduling server 102 determines a remaining time after reduction score (RTAR) for each conflicting meeting based on the determined original meeting duration (OMD) of the conflicting meeting and the requested meeting time reduction as determined in block 2110. In the illustrative embodiment, the calendar scheduling server 102 determines the remaining time after reduction score (RTAR) by determining the percentage of the remaining time of the conflicting meeting after reduction to the original meeting duration (OMD) weighted by a weighting factor, and with the addition of a penalty that is based on the original meeting duration (OMD). For example, in the illustrative embodiment, the calendar scheduling server 102 may determine the remaining time after reduction score (RTAR) using the following equation: RTAR=(((OMD−MTR)/MTR)×WF1)+PEN, wherein RTAR is the remaining time after reduction score, OMD is the original meeting duration, MTR is the required meeting time reduction determined in block 2110, WF1 is a weighting factor, and PEN is the penalty based on the original meeting time duration (OMD). The particular values for the weighting factor WF1 and the penalty PEN may be dependent on the particular implementation. However, in the illustrative embodiment, WF1 is equal to 0.2 and PEN is equal to −0.5 if OMD≤45 minutes; −0.3 if 45 minutes<OMD≤1 hour; −0.1 if 1 hour<OMD≤2 hours; and 0.0 if OMD<2 hours. In this way, the assigned penalty PEN is configured to prioritize those conflicting meetings for which the reduction in time is a smaller percentage of the overall meeting duration over those conflicting meetings in which the reduction in time is a greater percentage of the overall meeting duration (e.g., reducing the duration of a 2 hour meeting by 15 minutes will be prioritized over reducing the duration of a 45 minute meeting by 15 minutes).

Subsequently in block 2124, the calendar scheduling server 102 determines the reduction feasibility score (RFS) for the conflicting meeting under consideration based on the normalized MRS determined in block 2118 and the RTAR determined in block 2122. In doing so, the calendar scheduling server 102 may be configured to sum a weighted nMRS and a weighted RTAR to determine the reduction feasibility score (RFS). For example, in the illustrative embodiment, the calendar scheduling server 102 may determine the reduction feasibility score (RFS) using the following equation: RFS=(nMRS×WF1)+ (RTAR×WF2), wherein RFS is the reduction feasibility score, nMRS is the normalized meeting reschedule score, WF1 is a first weighting factor, RTAR is the remaining time after reduction score; and WF2 is a second weighting factor. The particular values for the weighting factors WF1 and WF2 may be dependent on the particular implementation. However, in the illustrative embodiment, WF1 is equal to 0.6 and WF2 is equal to 0.4.

After the calendar scheduling server 102 has determined the reduction feasibility score for each conflicting meeting in block 2116, the method 2100 advances to block 2126 of FIG. 21B. In block 2126, the calendar scheduling server 102 filters or otherwise removes those time slots from considerate that are associated with conflicting meetings having a reduction feasibility score (RFS) less than a minimum threshold amount. For example, in the illustrative embodiment, the calendar scheduling server 102 removes any time slots having conflicting meetings with an RFS of less than 0.6.

Subsequently, in block 2128, the calendar scheduling server 102 is configured to rank the remaining time slots base don the number of conflicting meetings associated with each time slot, which are available for reduction of their corresponding meeting time. In doing so, the calendar scheduling server 102 prioritizes (e.g., lists in order) those time slots having fewer overlapping, conflicting meetings in block 2130. In block 2132, the calendar scheduling server 102 determines an average reduction feasibility score (RFS) for each time slot based on each of the conflicting meetings of that respective time slot. In doing so, in block 2134, the calendar scheduling server 102 may re-rank (e.g., change the order of) the time slots so as to prioritize those time slots having a higher average reduction feasibility score (RFS).

In block 2136, the calendar scheduling server 102 considers the next time slot and its associated conflicting meeting(s) according to the ranked order produced from blocks 2128 and 2132. In doing so, the calendar scheduling server 102 is configured to request approval for the meeting time reduction from the host participant for any conflicting meeting having a reduction feasibility score (RFS) greater than a minimum threshold in block 2138. For example, in the illustrative embodiment, the calendar scheduling server 102 is configured to request the host participant's approval for any conflicting meeting having a reduction feasibility score (RFS) greater than 0.6. In this way, the calendar scheduling server 102 is configured to step through each conflicting meeting of the present time slot under consideration and request host participant approval, if required.

Subsequently, in block 2140, the calendar scheduling server 102 determines whether all required approvals have been received. If not, the method 2100 loops back to block 2136 in which the next time slot is considered according to the ranked order. However, if all required approvals for the conflicting meeting(s) of the time slot presently under consideration have been received in block 2140, the method 2100 advances to block 2142. In block 2142, the calendar scheduling server 102 reduces the meeting time duration of the approved conflicting meeting to facilitate the scheduling of the requested meeting in an adjacent or nearby time slot. In this way, even if a conflicting meeting cannot be rescheduled, the meeting duration of the conflicting meeting(s) may be able to be shortened to facilitate the scheduling of the requested meeting.

Referring again back to FIG. 16A, after the calendar scheduling server 102 attempts to reschedule any conflicting meeting in block 1628 using the method 2000 described above, the calendar scheduling server 102 determines whether a new meeting time slot was successfully identified by rescheduling those conflicting meetings in block 1632. If not, the method 2000 advances to block 1634, in which the calendar scheduling server 102 informs the host (e.g., the sender of the email) that no available meeting time slot could be identified and, as such, the meting was not scheduled. If, however, the calendar scheduling server 102 did identified a new meeting time slot by rescheduling one or more conflicting meetings, the method 2000 advances to block 1636 in which the calendar scheduling server 102 automatically schedules the requested meeting in the identified time slot of each participant's digital calendar as discussed further below.

Referring back to block 1626, if the calendar scheduling server 102 was able to identify a suitable time slot in which to schedule the requested meeting, the method 1700 also advances to block 1634. Again, in block 1634, the calendar scheduling server 102 automatically schedules the requested meeting in the identified time slot of each participant's digital calendar. That is, in the illustrative embodiment, the calendar scheduling server 102 is configured to schedule the meeting in the identified time slot without interaction or acceptance from any of the participants of the requested meeting. Rather, the meeting is scheduled in the identified time slot based on the availability of the participant (and, perhaps, the reschedule-ability of a conflicting meeting) and, as such, may be scheduled within seconds (e.g., less than 10 seconds) of the calendar scheduling server 102 receiving the requesting email.

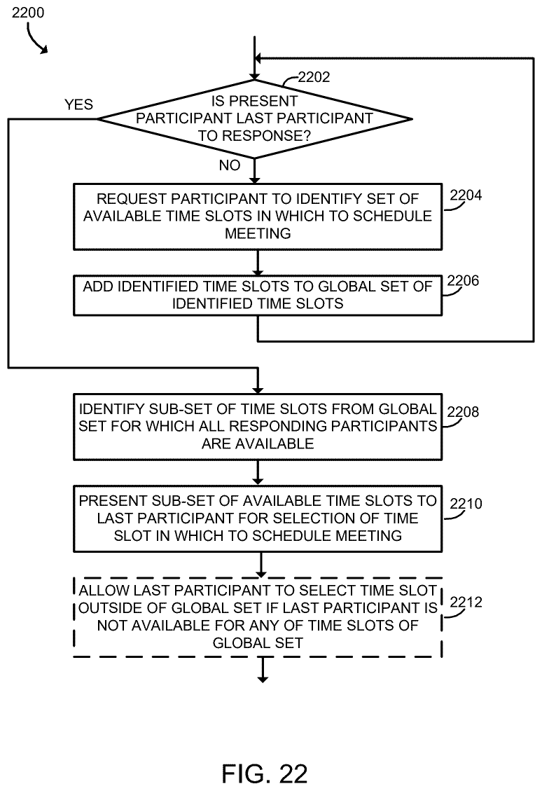

Referring now to FIG. 22, in some embodiments, the calendar scheduling server 102 may be configured to request non-registered users (i.e., users whose digital calendar is not maintained by the calendar scheduling server 102) to specifically identify available time slots on their digital calendar. To do so, the calendar scheduling server 102 may execute a method 2200 for identifying available time slots for unregistered users. The method 2200 may be executed as part of block 1616, 1618, or block 1628 in some embodiments.

The method 2200 begins with block 2202 in which the calendar scheduling server 102 determines whether the present participant is the last participant to respond to the invite to connect their calendar (e.g., to respond to the invite sent in block 1612 of method 1600). If not, the method 2200 advances to block 2204 in which the calendar scheduling server 102 requests the participant to identify a set of time slots for which that participant is available for the requested meeting. The number of time slots the participant may identify may be dependent on the particular implementation. In an illustrative embodiment, the calendar scheduling server 102 is configured to request the participant to identify three available time slots, but may request more or fewer in other embodiments.

After the participant has identified the set of time slots for which she/he is available, the method 2200 advances to block 2206. In block 2106, the calendar scheduling server 102 adds the identified time slots to the global set of time slots identified by other non-registered participants of the requested meeting. In this way, the global set of time slots identifies all the time slots for which the non-registered participants are available. Additionally, in some embodiments, the global set of time slots may also include the available time slots of registered participants. Regardless, after the calendar scheduling server 102 has updated the global set of available time slots, the method 2200 loops back to block 2202 in which the calendar scheduling server 102 awaits a response from the next non-registered participant.

If, in block 2202, the calendar scheduling server 102 determines the present participant is the last participant, the method 2200 advances to block 2208. In block 2208, the calendar scheduling server 102 identifies a sub-set of time slots from the global set of available time slots for which each non-registered participant that has responded is available, along with each registered participant (i.e., those participants for whom the calendar scheduling server 102 maintains a digital calendar). That is, the sub-set of time slots identifies each time slot for which each non-registered and registered participant except, perhaps, the last participant, is available. Subsequently, in block 2210, the calendar scheduling server 102 presents the sub-set of time slots to the last participant and requests the last participant to select one of those time slots in which to schedule the requested meeting. In some embodiments, in block 2212, the calendar scheduling server 102 may allow the last participant to select one or more time slots for which she/he is available if they are unavailable for all of the time slots included in the sub-set of time slots. For example, the calendar scheduling server 102 may allow the last participant to select a time slot beyond the initially identified range of days. In this way, the time required to schedule the meeting may be improved by reducing the complexity of identifying available time slots for non-registered users.

While the disclosure has been illustrated and described in detail in the drawings and foregoing description, such an illustration and description is to be considered as illustrative and not restrictive in character, it being understood that only illustrative embodiments have been shown and described and that all changes and modifications that come within the spirit of the disclosure are desired to be protected.

There are a plurality of advantages of the present disclosure arising from the various features of the methods, apparatuses, and systems described herein. It will be noted that alternative embodiments of the methods, apparatuses, and systems of the present disclosure may not include all of the features described yet still benefit from at least some of the advantages of such features. Those of ordinary skill in the art may readily devise their own implementations of the methods, apparatuses, and systems that incorporate one or more of the features of the present invention and fall within the spirit and scope of the present disclosure as defined by the appended claims.

1. A method for automated scheduling of a meeting, the method comprising:
receiving, by a server computer, an email communication from a sender, the email including an indicator that indicates a request by the sender to schedule the meeting;
determining, by the server computer, a set of participants for the requested meeting based on the email;
allocating, by the server computer, each day within a range of days into time slots having predefined temporal lengths to define a plurality of time slots;
assigning, by the server computer, an availability score for each time slot of the plurality of time slots based on an indicated availability of each participant of the set of participants for the corresponding time slot;
determining, by the server computer, a time slot bonus for each time slot of the plurality of time slots based on the time of day associated with the corresponding time slot;
determining, by the server computer, a day penalty for each time slot of the plurality of time slots based on a temporal distance from a present day to the day in which the corresponding time slot occurs;
determining, by the server computer, a time slot score for each time slot of the plurality of time slots based on the availability score, the time slot bonus, and the day penalty associated with each corresponding time slot;
selecting, by the server computer, a time slot from the plurality of time slots based on the time slot score of each corresponding time slot; and
scheduling, by the server computer, the requested meeting for the selected time slot on a digital calendar of each participant of the set of participants.

2. The method of claim 1, wherein allocating each day into time slots comprises allocating each day into 30 minute time slots.

3. The method of claim 1, wherein assigning the availability score comprises assigning, by the server computer, a higher availability score to a time slot of the plurality of time slots in response to a determination that a participant associated with the time slot is available and a lower availability score if the participant associated with the time slot is not available.

4. The method of claim 1, wherein assigning the availability score comprises classifying each participants availability within each time slot into one of three classifications including an available category, a not-available category, and an available-if-required category.

5. The method of claim 1, wherein the time slot bonus is greater for those time slots corresponding to an hour between 9:00 AM and 5:00 PM relative to those time slots occur at another time on the same day.

6. The method of claim 1, wherein determining a day penalty for each time slot of the plurality of time slots comprises assigning, by the server computer, a first day penalty to a first time slot of the plurality of time slots and a second day penalty to a second time slot of the plurality of time slots, wherein the first day penalty is greater than the second day penalty and the first time slot occurs on a day that is subsequent to a day on which the second time slot occurs.

7. The method of claim 1, wherein determining the time slot score for each time slot of the plurality of time slots comprises determining a base time slot score for each time slot of the plurality of time slots as a sum of the (i) number of participants available for the corresponding time slot weighted by a first weighting factor and (ii) the number of participants available-if-required for the corresponding time slot weighted by a second weighting factor different from the first weighting factor.

8. The method of claim 7, wherein determining the time slot score for each time slot of the plurality of time slots comprises determining, by the server computer, the total time slot score by adding the time slot bonus for each respective time slot to the base time slot score determined for that respective time slot and subtracting the day penalty determined for that respective time slot.

9. The method of claim 1, wherein determining the time slot score for each time slot of the plurality of time slots comprises determining, by the server computer, the time slot score for each respective time slot according to the following equation:
TSₜ=ASₜ+TBₜ−DPₜ,
wherein TSₜ is the time slot score for time slot “t”, ASₜ is the availability score for time slot “t”, and DPₜ is the day penalty slot score for time slot “t”.

10. The method of claim 1, further comprising
identifying, by the server computer, a conflicting meeting of at least one participant of the set of participants that conflicts with the selected time slot;
determining, by the server computer, whether the conflicting meeting can be rescheduled; and
adjusting, by the server computer, the conflicting meeting on the digital calendar of the at least one participant to a different time slot than the selected time slot.

11. The method of claim 10, wherein determining whether the conflicting meeting can be rescheduled comprises:
determining, by the server computer, a participant priority score (PPS) for each participant of the set of participants, wherein the participant priority score is indicative of an importance of each participant relative to the other participants of the set of participants;
determining, by the server computer, a meeting reschedule score (MRS) for each of the requested meeting and the conflicting meeting, wherein the meeting reschedule score is indicative of a difficulty of rescheduling the corresponding meeting;
determining, by the server computer, a time sensitivity score (TSS) for each of the requested meeting and the conflicting meeting, wherein the time sensitivity score is indicative of an urgency of the corresponding meeting;
determining, by the server computer, a meeting priority score (MPS) for each of the requested meeting and the conflicting meeting as a function of the participant priority score, the meeting schedule score, and the time sensitivity score for each respective meeting, wherein the meeting priority score is indicative of a relative priority of the corresponding meeting; and
determining, by the server computer, whether the conflicting meeting can be rescheduled based on the meeting priority score of the requested meeting and the meeting priority score of the conflicting meeting.

12. The method of claim 11, wherein determining the participant priority score comprises:
determining, by the server computer and for each participant of the set of participants, a calendar score based on an amount of availability of the corresponding participant over a defined time period;
determining, by the server computer and for each participant of the set of participants, a hierarchy score indicative of a seniority of the corresponding participant relative to other participants of the set of participants; and
determining, by the server computer, the participant priority score (PPS) for each participant of the set of participants based on the calendar score and the hierarchy score determined for each corresponding participant.

13. The method of claim 11, wherein determining the meeting reschedule score for each of the requested meeting and the conflicting meeting comprises:
determining, by the server computer, a base meeting reschedule score for each of the requested meeting and the conflicting meeting as a function of a company affiliation and a registration status of each participant, wherein the company affiliation is indicative of whether the corresponding participant is an employee of the same company as the sender and the registration status is indicative of whether the corresponding participant utilizes a digital calendar maintained by the server computer; and
adjusting, by the server computer, the base meeting reschedule score in response to determination of whether the conflicting meeting has previously been rescheduled; and
adjusting, by the server computer, the base meeting reschedule score in response to a determination of a level of importance of the corresponding conflicting meeting and requested meeting.

14. The method of claim 11, wherein determining the time sensitivity score comprises:
determining, by the server computer, a context of each of the requested meeting and the conflicting meeting; and
determining, by the server computer, a time sensitivity score (TSS) for each of the requested meeting and the conflicting meeting based on the determined context of the corresponding requested meeting and conflicting meeting.

15. The method of claim 11, wherein determining the meeting priority score for each of the requested meeting and the conflicting meeting comprises:
determining, by the server computer, an average participant priority score (APPS) as a function of the participant priority score (PPS) for each participant of each corresponding requested meeting and conflicting meeting and a total number of participants for each corresponding requested meeting and conflicting meeting;
normalizing, by the server computer, each meeting reschedule score (MRS), each average participant priority score (APPS), and each time sensitivity score (TTS) to a score in the range of 0 to 1.0; and
determining, by the server computer, the meeting priority score for each of the requested meeting and the conflicting meeting as a sum of the corresponding normalized MRS weighted by a first weighting factor, the corresponding normalized APPS weighted by a second weighting factor, and the normalized TTS weighted by a third weighting factor.

16. The method of claim 15, wherein determining the meeting priority score for each of the requested meeting and the conflicting meeting comprises determining the meeting priority score according to the following equation:
MPSₘ=(nMRSₘ×WF1)+(nAPPSₘ×WF2)+(nTSSₘ×WF3),
wherein MPSₘ is the meeting priority score for meeting “m”, nMRSₘ is the normalized meeting reschedule score for meeting “m”, WF1 is the first weighting factor, nAPPSₘ is the normalized average participant priority score for meeting “m”, WF2 is the second weighting factor, nTSSₘ is the normalized time sensitivity score for meeting “m”, and WF3 is the third weighting factor.

17. The method of claim 11, further comprising:
identifying, by the server computer, a set of identified time slots within the range of days from the conflicting meeting to which the conflicting meeting may be moved;
determining, by the server computer, a participant preference score difference (PSD) for each identified time slot, wherein the participant preference score defines a preference of a corresponding participant for the conflicting meeting relative to the corresponding identified time slot;
determining, by the server computer, a time delay cost (TDC) for each identified time slot, wherein the time delay cost is indicative of a reduction of an urgency of the conflicting meeting as a function of temporal distance between the conflicting meeting and the corresponding time slot;
determining, by the server computer, a rescheduling cost (RC) for each conflicting meeting as a function of the meeting priority score (MPS) of the conflicting meeting, the participant preference score difference (PSD) for each participant of the conflicting meeting, and the time delay cost (TDC) of the corresponding identified time slot; and
selecting a time slot associated with one or more conflicting meetings based on the rescheduling cost (RC) of each identified time slot.

18. The method of claim 17, wherein determining the rescheduling cost (RC) for each identified slot comprises determining the rescheduling cost according to the following equation:
RCₛ=(MPS_{c}×WF1)+(PSD_{c}×WF2)+(TDCₛ×WF3),
wherein RCₛ is the rescheduling cost for the identified time slot “s,” MPS_{c} is the meeting priority score for conflicting meeting “c”, WF1 is a first weighting factor, PSD_{c} is the participant preference score difference for each participant of the conflicting meeting “c”, WF2 is a second weighting factor, TDCₛ is the time delay cost for the identified time slot “s”, and WF3 is a third weighting factor.

19. The method of claim 17, wherein selecting the time slot associated with one or more conflicting meetings comprises selecting the time slot having the lowest rescheduling cost (RC).

20. The method of claim 17, wherein determining whether it can be moved comprises the rescheduling cost of the conflicting meeting to a rescheduling cost of another conflicting meeting occurring in a different time slot.
